(19) United States
(12) Patent Application Publication
(10) Pub. No.: US 2010/0030620 A1
(43) Pub. Date: Feb. 4, 2010

(54) SYSTEM AND METHOD FOR NETWORKING SHOPS ONLINE AND OFFLINE

(75) Inventors: Louise J. Wannier, Pasadena, CA (US); James P. Lambert, Toluca Lake, CA (US); Eric Jennings, Reno, NV (US); Mercedes De Luca, Saratoga, CA (US); Louisa Anna Simpson, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: myShape, Inc., Glendale, CA (US)

(21) Appl. No.: 12/494,244

(22) Filed: Jun. 29, 2009

Related U.S. Application Data
(60) Provisional application No. 61/077,118, filed on Jun. 30, 2008.

(51) Int. Cl. G06Q 30/00; G06Q 10/00; G06F 17/30; G06F 3/048; G06Q 50/00

(52) U.S. Cl. 705/10; 705/27; 707/5; 715/760; 707/E17.044; 707/E17.017; 707/E17.031

(57) ABSTRACT

A computer implemented method presents garments to a consumer using a computer by reading a garment database. The database includes garments from a plurality of retail, manufacturing, and media partners. Media and retail partners combine inventories on data servers and allow each partner to show a particular offering of garments at their website. A given partner may tailor the particular garment offering to subscribers based on a profile relating to the garment parameters contained within the database inventory. Applications within the system produce outfits composed of garment selections based on particular user profile information. Outfits selections are presented to the user through a web browser where shopping and purchasing of various garments may be conducted. The computer implemented method is facilitated through databases, database servers, application servers and networks to interrelate inventory offerings between the partners.

### CROSS-REFERENCE TO RELATED APPLICATIONS

This application claims benefit under 35 U.S.C. 119(e) of U.S. Provisional Patent Application No. 61/077,118 filed Jun. 30, 2008, which is herein incorporated by reference in its entirety for all purpose.

The present disclosure may be related to the following commonly assigned applications/patents:

U.S. Pat. No. 7,398,133 entitled “Matching the Fit of Individual Garments to Individual Consumers” issued to Wannier et al. (hereinafter “Wannier I”);

U.S. patent application Ser. No. 11/697,688, filed Apr. 6, 2007, entitled “Computer System for Rule-Based Clothing Matching and Filtering Considering Fit Rules and Fashion Rules” in the name of Wannier et al. (hereinafter “Wannier II”);

U.S. Provisional Patent Application No. 61/049,431, filed May 1, 2008, entitled “System and Method for Networking Shops Online and Offline” in the name of Wannier et al. (hereinafter “Wannier III”); and

U.S. Provisional Patent Application No. 61/077,116 filed of even date herewith, entitled “System and Method for Networking Shops Online and Offline” in the name of Wannier et al. (hereinafter “Wannier IV”).

The respective disclosures of these applications/patents are incorporated herein by reference in their entirety for all purposes.

### FIELD OF THE INVENTION

The present invention relates generally to computer systems for providing consumer access to databases of clothing items and in particular to computer systems that programmatically match clothing items with individual consumers' data, possibly including searching, sorting, ranking, and filtering database items from a plurality of partners.

### BACKGROUND OF THE INVENTION

Consumers often have difficulties finding apparel that fits and flatters. III-fitting garments do not sell and are often returned when they do sell. One cause of fit problems is a lack of standards. Without standardization, the garment size for an individual often differs from one brand of apparel to another. There have been multiple attempts to establish commercial standards for sizing garments. Clothing manufacturers and retailers have repeatedly redefined the previous standards or invented their own proprietary sizing schemes. Even within a single size from a single manufacturer, there can be fit problems because of a wide variation in consumers' body shapes. The lack of sizing standards combined with unreliable labeling can cause apparel fit problems, which in turn causes a very high rate of apparel returns, lost sales, brand dissatisfaction, time wasted in fitting rooms, and intense consumer frustration.

As more consumers rely on online information about products for purchase, more merchants provide electronic access to information about goods and services over the Internet. Typically, a merchant compiles a database of products and/or services, which may include information about a product's size, color, type, description, price, etc. Consumers can view the merchant's offerings over the Internet, select items of interest, and place orders with the merchant's interface.

Online shopping is significantly restricted compared to visiting a store in person. The consumer has no direct contact with the product. Where the product has a greater personal impact, such as fit, this shortcoming has more significance. For example, in fashion shopping, ordering clothing, accessories, shoes, purses, and any products incorporating a style sense, online shopping is limited. Fashion intrinsically includes shopping and purchasing something that is new and different. In clothing shopping, without the actual garment to see and try on, there is no way to visualize how the article matches a particular fashion sense or fits.

A number of approaches have been tried to bridge the gap between online shopping for clothing, shoes, or other fashion items and having the item in hand to try on. One approach has been to custom tailor the article of clothing from the customer's measurements. Other approaches have incorporated a scanned image of the customer with a geometric model of a garment that, when combined through computer graphic techniques, provides an image of the consumer wearing the garment. A further system relates photographic color systems to a color classification scheme. Colors may be automatically grouped by a fashion type, stylist, or particular color palette. One system categorizes women into “winter, summer, fall, spring” color palettes, based on their skin, eye and/or hair colors.

Another attempt to solve these challenges involves analyzing a large market population and producing a garment's design based on a corresponding range of sampled body shapes. From this, manufacturers tend to produce a particular pant in several body shapes to offer fit choices corresponding to the sampled body shapes. This approach relies on trial and error by the consumer to locate and determine good fitting pants. Some online solutions have several stores trying to interrelate with one another through portals and cross-linked access to each affiliate's Web site. Customer's are often confused or lost by excursions through these portals.

An improved system and method for providing clothing choices to consumers and other individuals is needed.

### BRIEF SUMMARY OF THE INVENTION

In embodiments of computer-implemented methods for matching fit and fashion of individual garments to individual consumers according to the present invention, a server system accessible to users using client systems can match consumers with garments and provide an improved, online, clothes shopping system, where a consumer is presented with a personalized online clothing store, wherein the consumer using a consumer client system can browse a list of garments matching the consumer's dimensions, body shape, preferences and fashion needs, wherein the garments are also filtered so that those shown also match fit and fashion rules so that selected garments have a higher probability of both fitting and flattering.

A computer implemented method may present garments to a consumer using a computer by reading a database of garments, wherein the database of garments includes parameters for at least some of the garments represented by records in the database of garments. A database of garments is established from a plurality of retailers, merchants, and manufactures. By incorporating eight or so user measurements and body shape data, available from a user supplied profile, a match assessment may be made to any of a plurality of garments and accessories available in the database. In this way, the plurality of partners may make a wide variety of clothing articles available to a large number of online users. The online shopping experience can be provided through a wide ranging collection of databases, database servers, applications, application servers, and networks.

The following detailed description together with the accompanying drawings will provide a better understanding of the nature and advantages of the present invention.

### BRIEF DESCRIPTION OF THE DRAWINGS

FIG. 1 is an illustration of a clothes shopping system, in accordance with described embodiments.

FIG. 2 is a simplified block diagram of a consumer-garment matching method, in accordance with described embodiments.

FIG. 3 is a simplified block diagram of a definition process, in accordance with described embodiments.

FIGS. 4A-D illustrate height and length measurement techniques, in accordance with described embodiments.

FIGS. 5a-b are simplified block diagrams of a categorization process, in accordance with described embodiments; FIG. 5a shows a consumer recording process and FIG. 5b shows a garment recording process.

FIG. 6 is a simplified block diagram of a match assessment process, in accordance with described embodiments.

FIGS. 7-13 are flowcharts illustrating a match assessment process for a fitted dress, in accordance with described embodiments.

FIG. 14 is an illustration of example output from a match assessment process, in accordance with described embodiments.

FIG. 15 is an illustration of a garment display interface, in accordance with described embodiments.

FIGS. 16-18 are illustrations of clothes shopping systems, in accordance with described embodiments.

FIG. 19 is a block diagram of a linked lists creation process in accordance with described embodiments.

FIG. 20 is an illustration of a clothes shopping system, in accordance with described embodiments.

FIG. 21 is a block diagram of an outfit presentation process in accordance with described embodiments.

FIGS. 22-24 are block diagrams of a body shape, consumer, and garment categorization processes, in accordance with embodiments of the invention.

FIG. 25 is an illustration of a match system, in accordance with embodiments of the invention.

FIG. 26 is an illustration of a clothes shopping system, in accordance with described embodiments.

FIG. 27 is a block diagram of a preferred fashion presentation process in accordance with described embodiments.

FIGS. 28-30 are block diagrams of a fashion product and accessory presentation and recommendation processes in accordance with described embodiments.

FIG. 31 is a block diagram of an altered garment presentation process in accordance with described embodiments.

FIG. 32 is a block diagram of a garment profiling process in accordance with described embodiments.

FIG. 33 is an illustration of a clothes shopping system, in accordance with described embodiments.

FIGS. 34-36 are block diagrams of a user shopping update process in accordance with described embodiments.

### DETAILED DESCRIPTION

An improved online clothes shopping system is described herein, where a consumer is presented with a personalized online store that lists clothing items for sale that are most likely to fit and flatter the consumer and match their preferences for style. The presented list of items can be generated by a computerized garment-consumer matching method that matches the fit and fashion of individual clothing items to individual consumers.

Clothing items are commonly thought to include garments (dresses, coats, pants, shirts, tops, bottoms, socks, shoes, bathing suits, capes, etc.), but might also include worn or carried items such as necklaces, watches, purses, hats, accessories, etc. In any of the following examples, sized and fitted garments are the items being shopped for, but it should be understood that unless otherwise indicated, the present invention may be used for shopping for other clothing items as well. As used herein, an outfit is a collection of two or more clothing items intended to be worn or used together.

In describing embodiments of the invention, female consumers and women's apparel will serve as examples. However, the invention is not intended to be limited to women's apparel as the invention may be used for various types of apparel including men's and children's apparel. Throughout this description the embodiments and examples shown should be considered as exemplary rather than limitations of the present invention.

In a matching process, garments and consumers are compared. For garments, the measurements, style/proportion and attributes (color, weave, fabric content, price, etc.) might be taken into account, while for the consumer, measurements, body proportion (such as shape code), and consumer fit, style, and fashion preferences (how snug/loose, color, classic/contemporary/romantic, etc.), may be considered.

Fashion rules can be defined for various garment style(s) that suit body proportions, for garments and outfits, including accessorizing. Fashion rules (programmatically defining fashion expertise) can be “overlaid” on the matches to recommend the best combinations that will fit and flatter. In this manner, a consumer is presented with a number of garments to choose from, where each is likely to be a “good choice”, while 1 garments that are less likely to fit or flatter our left out. There could be a wide variety of garments and styles, etc., but they are organized as a personal store for that consumer.

### Clothes Shopping System

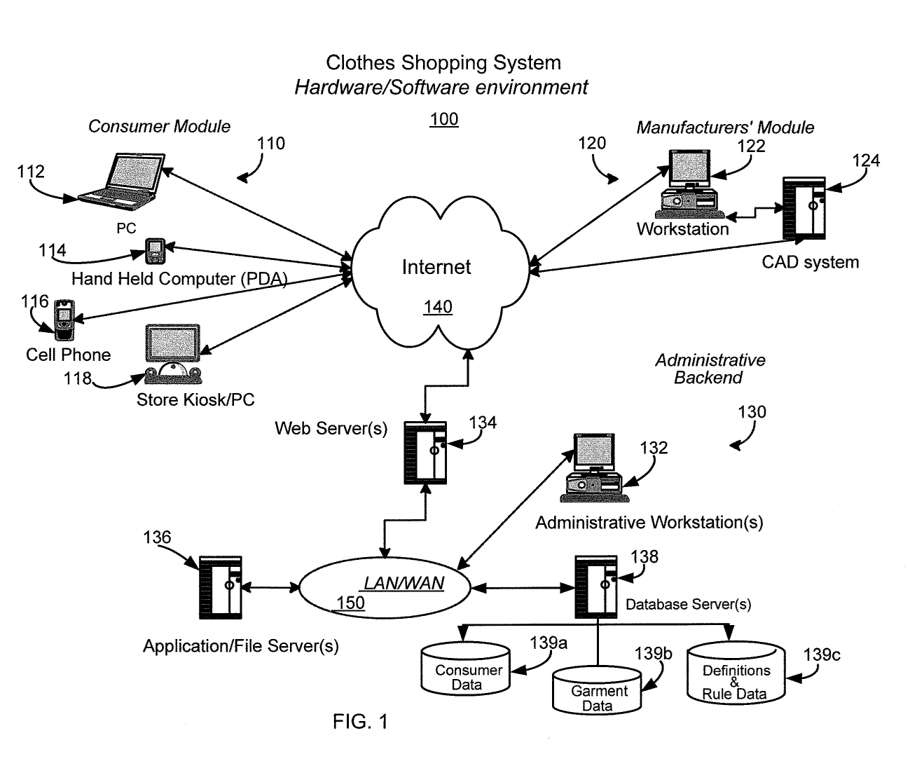

FIG. 1 is a high-level diagram depicting a clothes shopping system 100, which can be a computer implementation of a consumer-garment matching method in accordance with one embodiment of the present invention. The clothes shopping system can be client-server system, i.e., an assemblage of hardware and software for data processing and distribution by way of networks, as those with ordinary skill in the art will appreciate. The system hardware may include, or be, a single or multiple computers, or a combination of multiple computing devices, including but not limited to: PCs, PDAs, cell phones, servers, firewalls, and routers.

As used herein, the term software involves any instructions that may be executed on a computer processor of any kind. The system software may be implemented in any computer language, and may be executed as compiled object code, assembly, or machine code, or a combination of these and others. The software may include one or more modules, files, programs, and combinations thereof. The software may be in the form of one or more applications and suites and may include low-level drivers, object code, and other lower level software.

The software may be stored on and executed from any local or remote machine-readable media, for example without limitation, magnetic media (e.g., hard disks, tape, floppy disks, card media), optical media (e.g., CD, DVD), flash memory products (e.g., memory stick, compact flash and others), Radio Frequency Identification tags (RFID), SmartCards™, and volatile and non-volatile silicon memory products (e.g., random access memory (RAM), programmable read-only memory (PROM), electronically erasable programmable read-only memory (EEPROM), and others), and also on paper (e.g., printed UPC barcodes).

Data transfer to the system and throughout its components may be achieved in a conventional fashion employing a standard suite of TCP/IP protocols, including but not limited to Hypertext Transfer Protocol (HTTP) and File Transfer Protocol (FTP). The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein. An example network is the Internet, but the invention is not so limited.

In one embodiment, a clothes shopping system 100 comprising of a consumer module 110, a manufacturer module 120, and an administrative backend 130, all networked over local and/or wide area networks (LAN/WAN) 150, and the Internet 140. The administrative backend 130 uses administrator workstations 132, web servers 134, file and application servers 136, and database servers 138 that incorporate consumer-garment matching software, the consumer and garment record databases 139a-139b, definition & rules database 139c. The manufacturer module 120 uses software/hardware that allows a manufacturer to input data into the garment records. This data may be entered via a workstation 122 or by interfacing with the manufacturer's internal systems, such as CAD systems 124. This inputted garment data is subjected to a categorization process 220. The consumer module 110 is accessed via personal computers at home, office 112, or by cellular phones 116, PDAs 114, and kiosks 118.

### The Consumer-Garment Matching Method

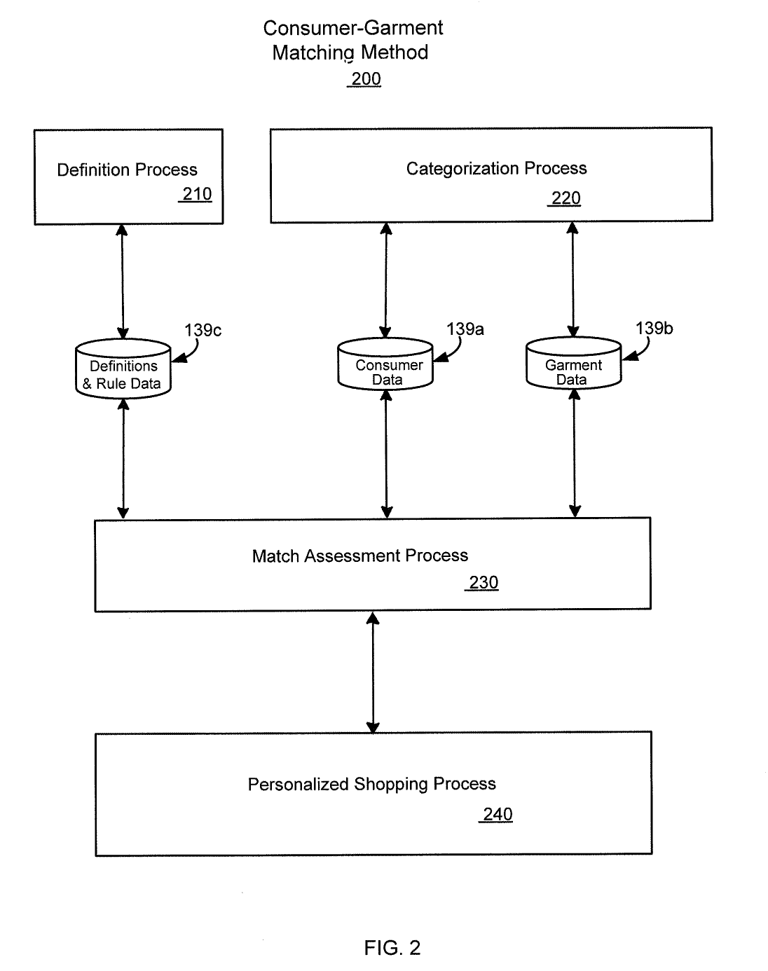

FIG. 2 is a simplified block-diagram depicting a consumer-garment matching method 200 and the data inputs, outputs and interdependence of its constituent processes: a definition process 210, a categorization process 220, a match assessment process 230, and a personalized shopping process 240, described herein.

### Definition Process

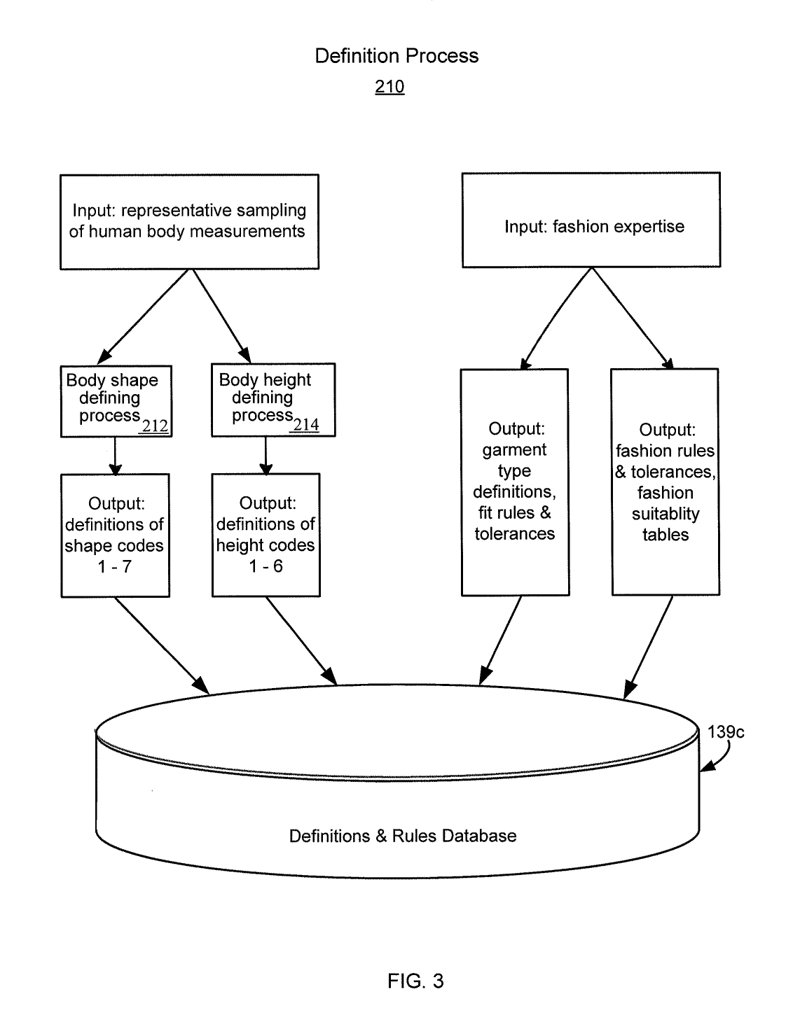

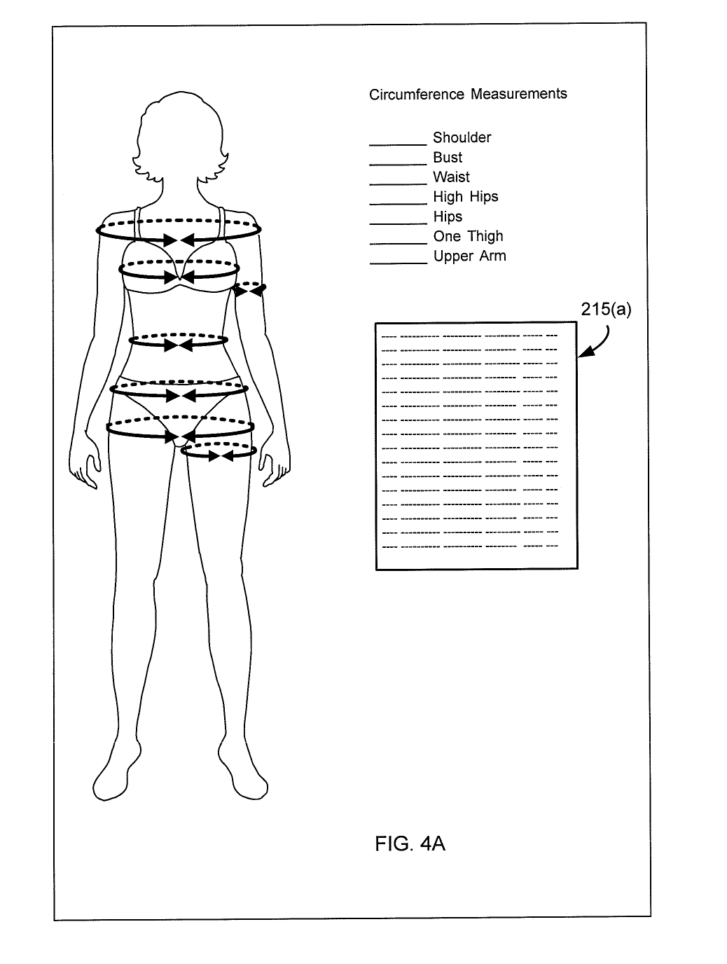

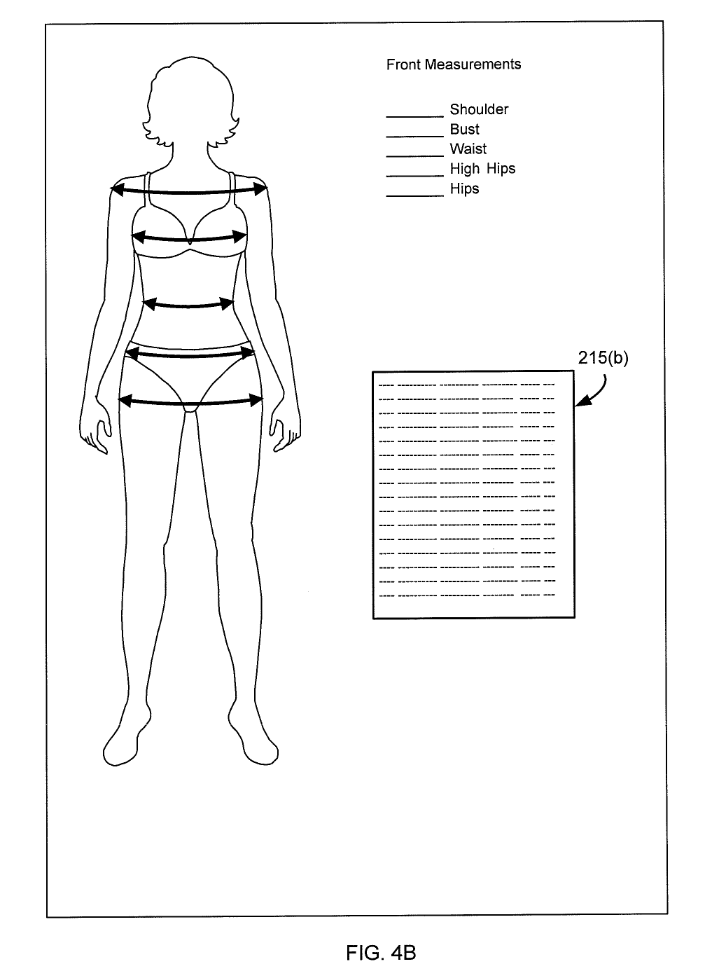

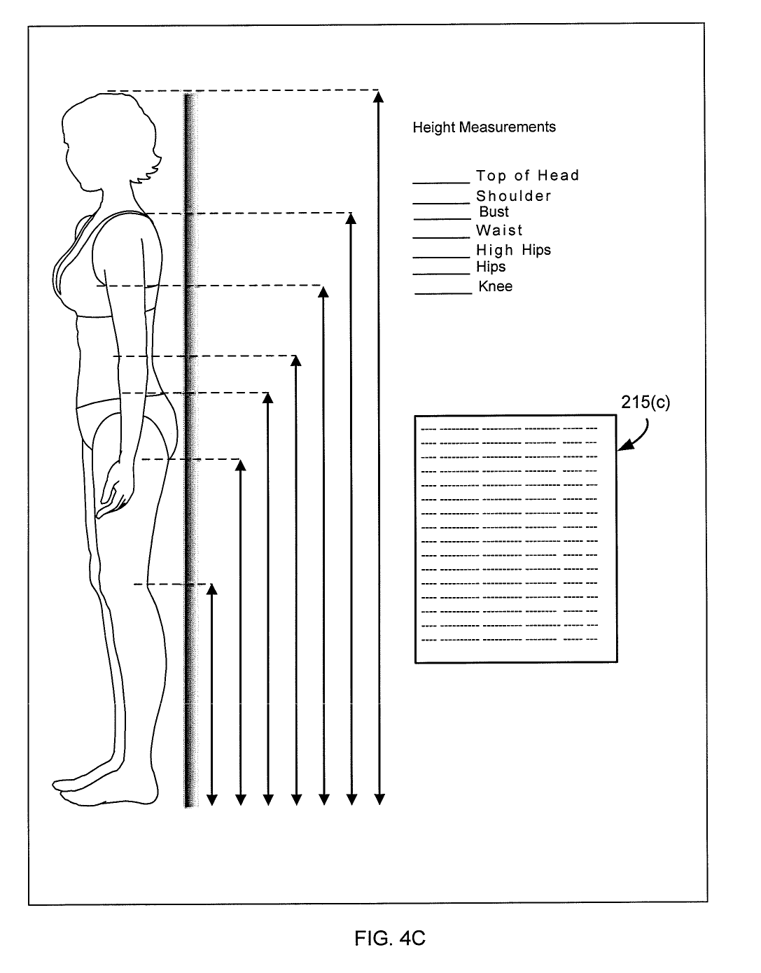

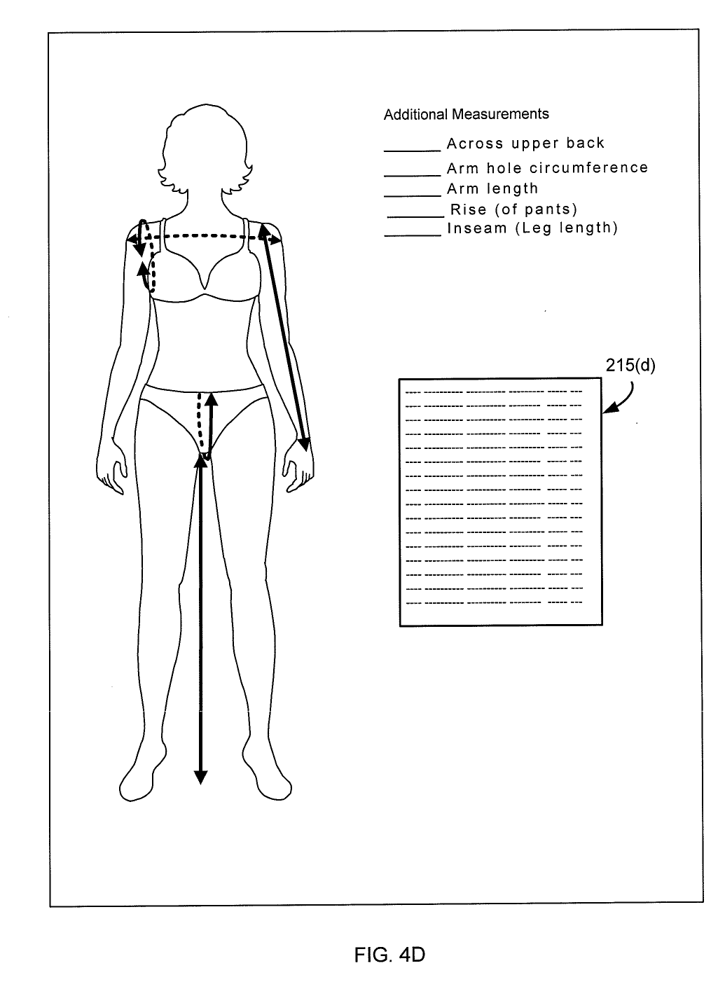

FIG. 3 depicts a definition process 210. Sets of measurements may be used by the categorization process 220 when collecting body measurement data from any individual consumer via the consumer module 110. FIGS. 4A-4D depict the positions and techniques for acquiring body measurements to obtain consumer data.

The displays of FIGS. 4A-4D might include instructions to the reader, as instruction blocks 215(a), 215(b), 215(c) and 215(d). Examples of instruction blocks are:

215(a) in FIG. 4A:

Measure the CIRCUMFERENCE of your body at various points.

Shoulders: Measure around shoulders, just below the shoulder joint, going outside your arms at the widest point.

Bust: Measure bust at fullest point and straight across back.

Waist: Measure around torso at your waistline.

High Hips: Measure over top of hip bones, 2″-4″ below waist.

Hips: Measure at the fullest part, usually 7″-9″ from waist.

One Thigh: Measure at the fullest part of one thigh on one leg (your choice).

Upper Arm: Measure the circumference of the thickest part of your upper arm (that bicep muscle!).

215(b) in FIG. 4B:

Measure the FRONT OF YOU from the middle of one side to the middle of the other only. It helps if you are wearing lightweight, form fitting clothes with side seams to help locate the side of your body.

Front of Shoulders: Measure from mid point of upper arm just below the shoulder joint to the same point of the opposite side, crossing the front of your body.

Front of bust: Measure from as close to middle of one side of your body to the middle of the other crossing over the fullest part of your bust.

Front of Waist: Measure from middle of one side to the middle of the other at your waist.

Front of High Hips: Measure over top of hip bones, 2″-4″ below waist.

Front of Hips: Measure from the middle of one side to the middle of the other at the fullest part of your hips, usually 7″-9″ from waist.

215(c) in FIG. 4C:

Measure the HEIGHT of the following by taping or attaching a measuring tape to the bottom of a wall or doorway (floor—measurement zero) to measure the heights. A book, ruler or straight edge can help. This will give a vertical silhouette.

Top of head: Measure from the floor to the top of your head.

Should height: Measure from the floor to the top of your shoulder joint.

Bust height: Measure from the floor to the fullest point of your bust.

Waist Height: Measure from the floor to your waistline.

High hip height: Measure from the floor to your high hip (your hip bone, usually 2″-4″ below your waist).

Hip height: Measure from the floor to the fullest point of your hips.

Knee height: Measure from the floor to the mid-point of your knee.

215(d) in FIG. 4D:

Almost done, just a few more!

Across upper back: Measure across your upper back from end of shoulder joint to end of shoulder joint. Or, for a shortcut, use a favorite jacket, measuring from shoulder seam to shoulder seam.

Arm hole circumference: Measure top of should under arm and back around to the top of the arm.

Arm length: Measure from the middle of the shoulder joint to the wrist joint, with slightly bent elbow.

Rise (of pants): Start at middle for your waist in back, pass tape measure between your legs and up to the middle of your waist in front. Do not pull tight on this measurement, and don't make it too loose. Keep comfort in mind and make sure you are measuring your body accurately. A shortcut is to measure your favorite pair of pants.

Inseam (leg length): Measure from the crotch to the floor on the inside of your leg.

Or, for a shortcut, measure the inseam of your favorite pair of pants.

Human body shapes are defined by a body shape defining process 212. Similarly, the same sample body measurement data form the inputs of a body height defining process 214. Definitions of body shape codes and body height codes are stored in the definitions & rules database 139c as maintained by database server 138. Thus these body shape codes may then be assigned by the categorization process 220. A similar or identical set of measurements may be used by the categorization process 220 when collecting garment measurement data for any individual garment via the manufacturer module 120. A garment type definition table specifies the measurements, tolerances and order of calculation to be used by the measurement filter 232 during a match assessment 230. Garment type definitions together with their fit rules and tolerances are stored in a definitions & rules database 139c as maintained by database server 138. The Fashion rules, tolerances and fashion suitability tables are stored by the definition process 210 in a definitions & rules database 139c as maintained by database server 138.

### Categorization Process

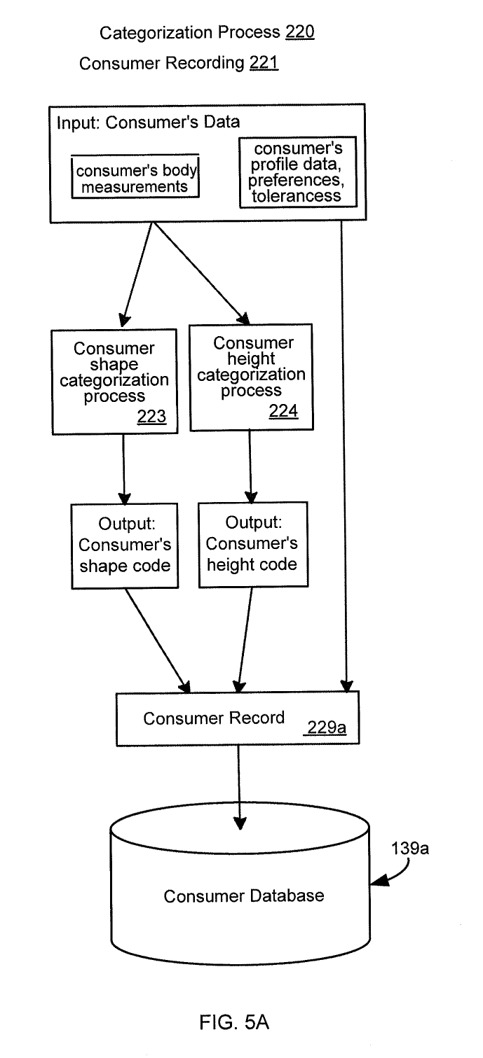

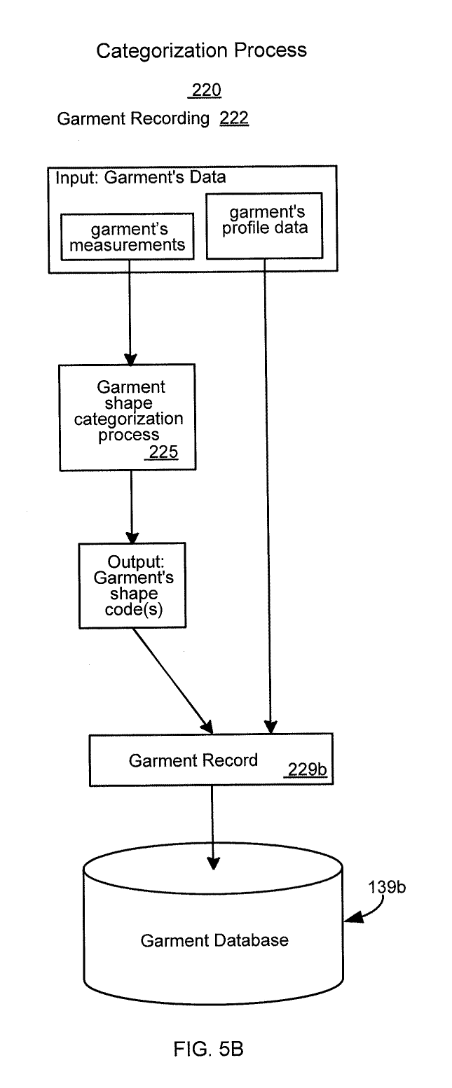

As embodied herein and depicted in FIGS. 5a-5b, a categorization process 220 has two sub-processes: consumer recording 221 (FIG. 5a) and garment recording 222 (FIG. 5b). A consumer record 229a is data describing an individual consumer. A garment record 229b is data describing an individual garment, including its measurements and profile, e.g., its color, fabric, tolerances, etc. The consumer records 229a are stored by the categorization process 220 in a consumer database 139a, while garment records 229b are stored in a garment database 139b. The consumer and garment databases are maintained by database server 138.

### Consumer Recording

An individual consumer's body measurements, such as those depicted in FIGS. 4A-4D, are input into a consumer shape categorization process 223. The resulting shape code is assigned to the consumer and stored in her record 229a. A consumer height categorization process 224 calculates a consumer's height code. The height categorization process is used to assign a height code to a consumer. The assigned height code can be stored in the consumer's record 229a.

### Garment Recording

The manufacturer module 120, described herein, supplies the garment measurements and profile data that form the inputs of the garment recording process 222. Referring again to FIGS. 5a-5b, a garment's measurements are inputs to a garment shape categorization process 225. The resulting shape codes are assigned to the garment and stored in its garment record 229b. The consumer records 229a can be stored in a consumer database 139a, while garment records 229b can be stored in a garment database 139b. The consumer and garment databases can be maintained by database server 138.

### Match Assessment Process

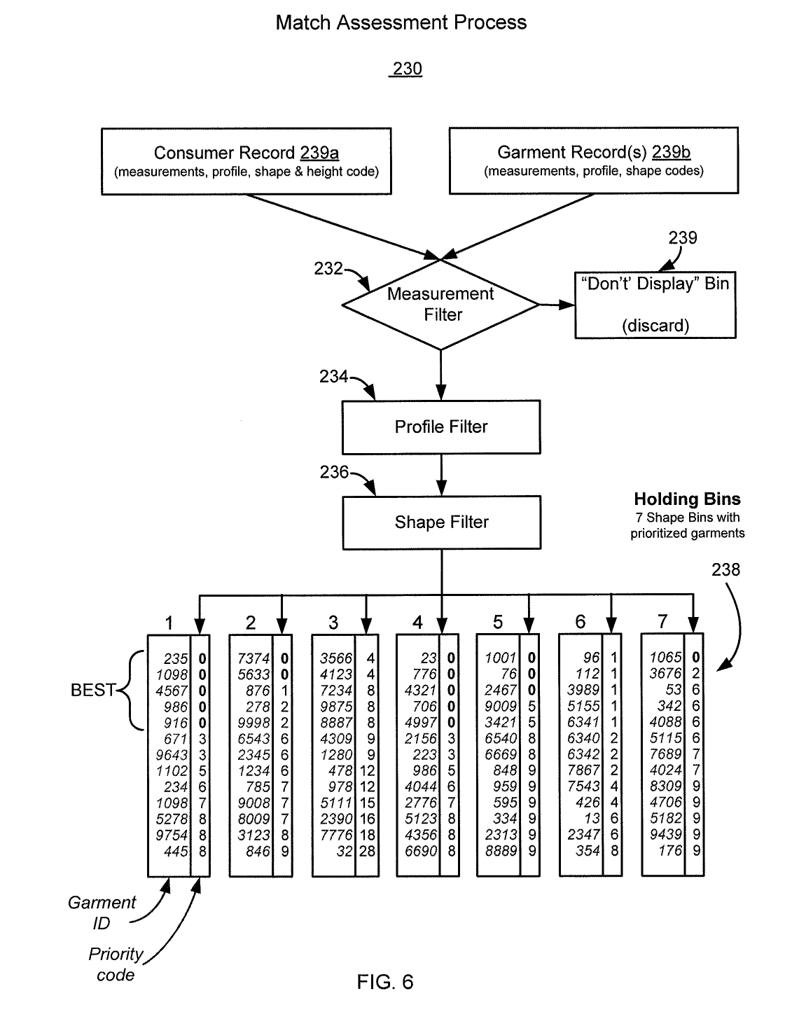

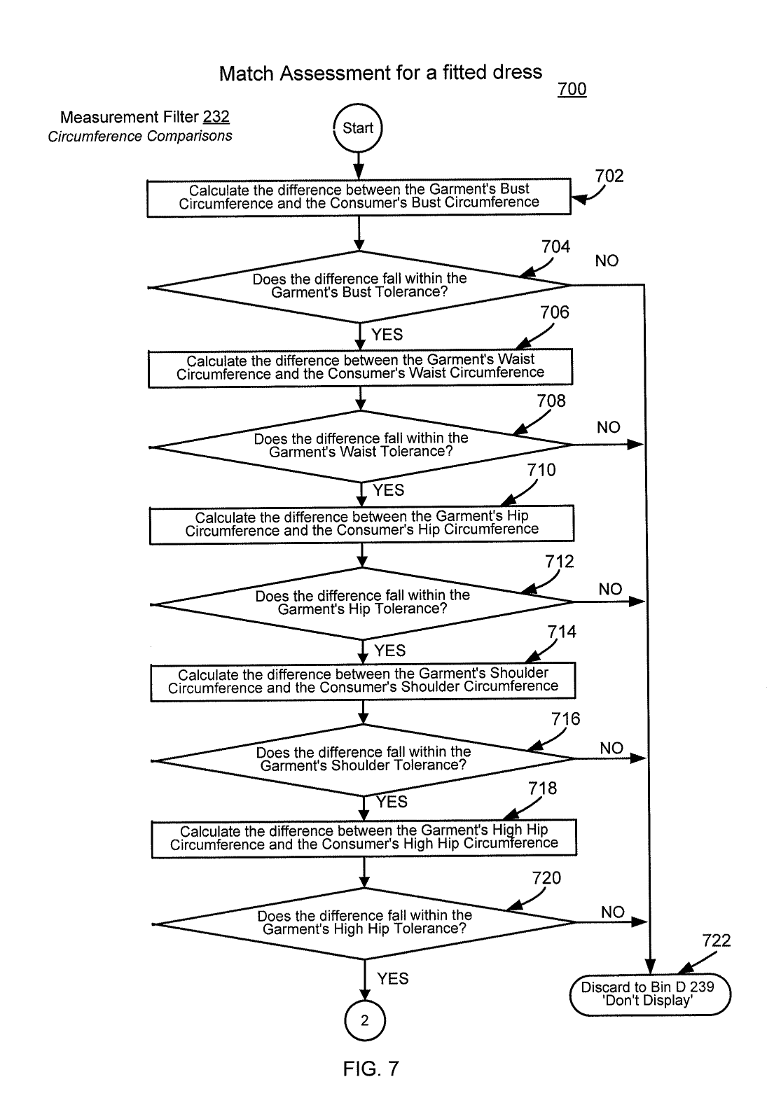

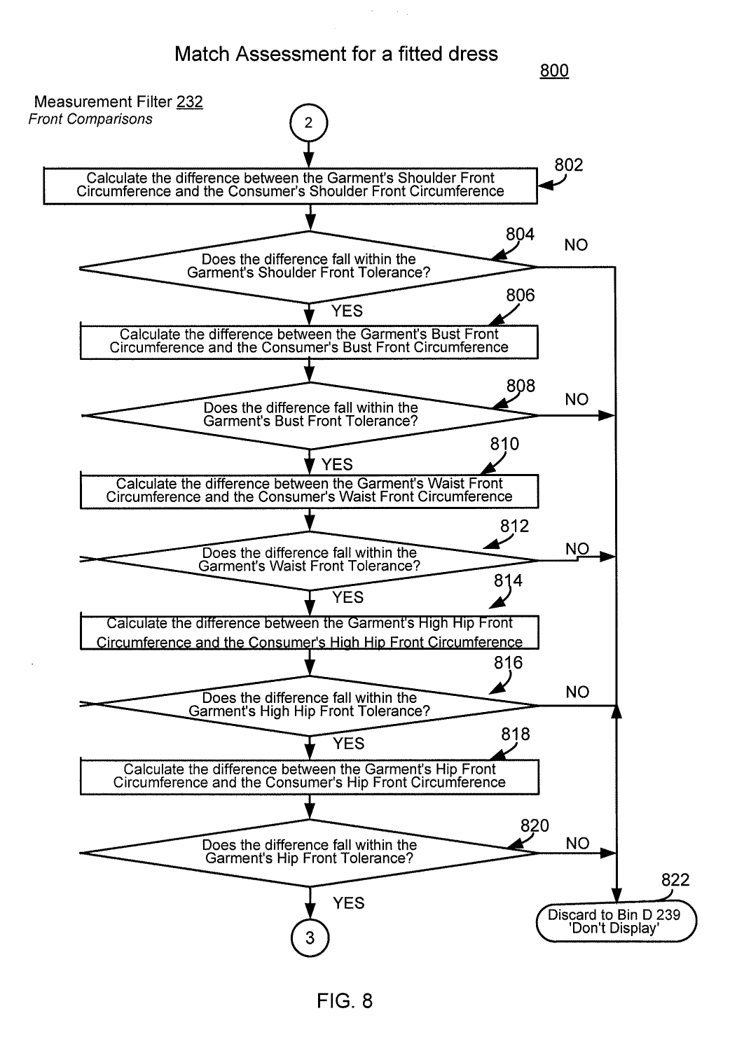

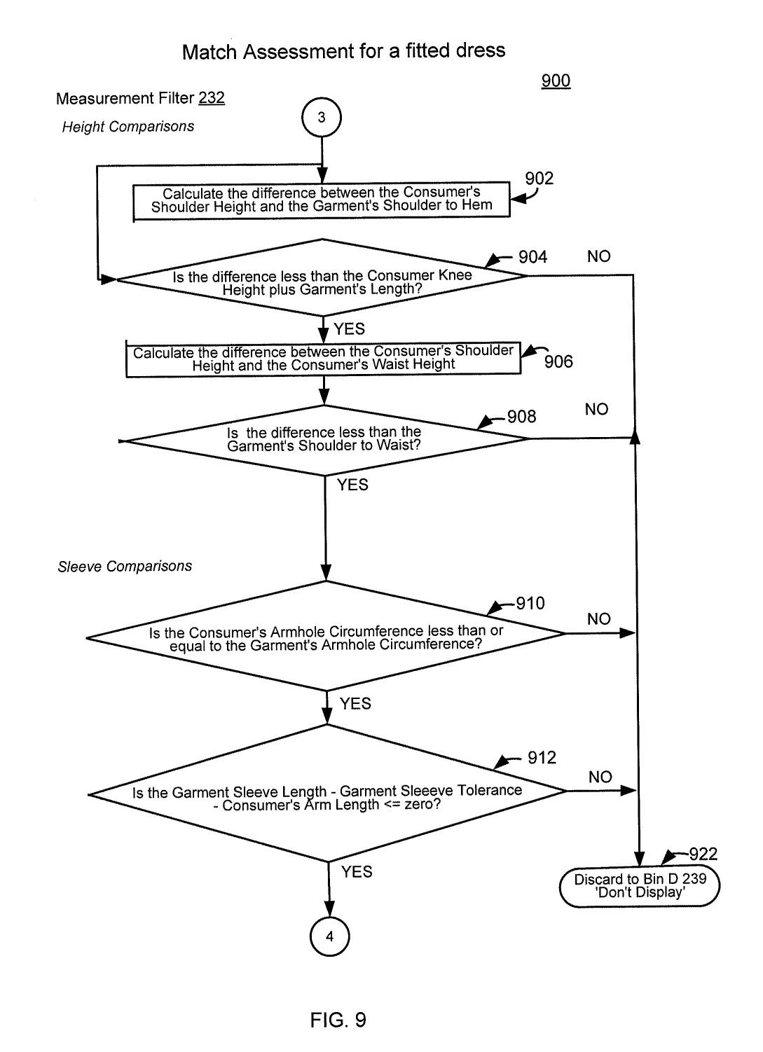

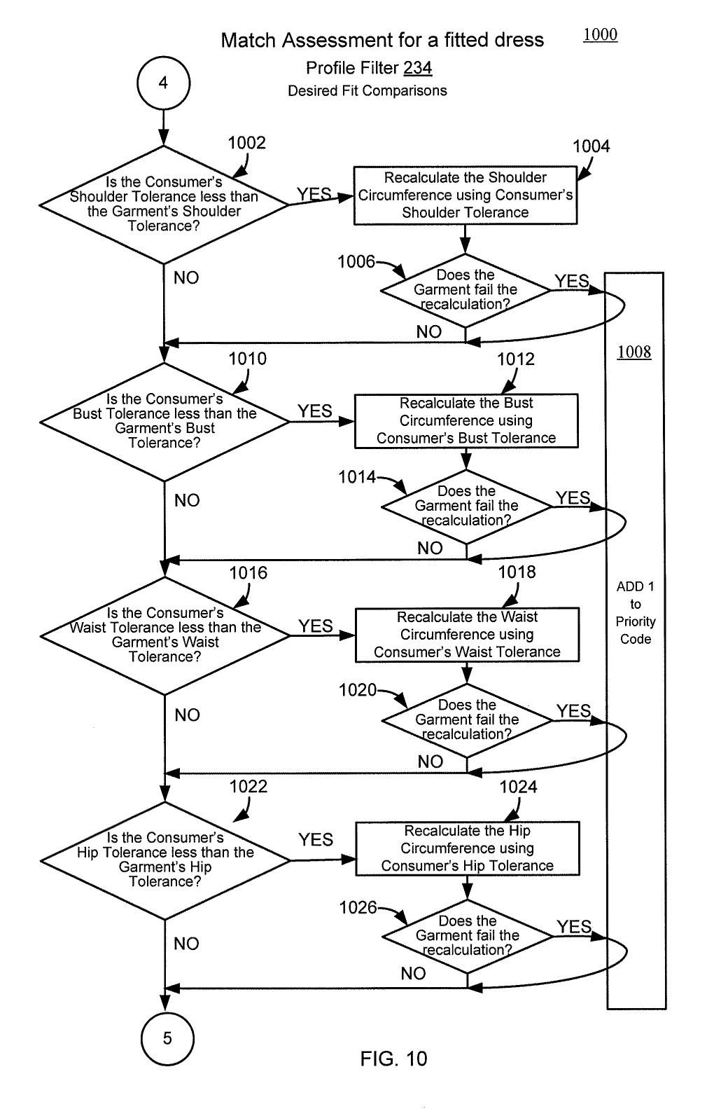

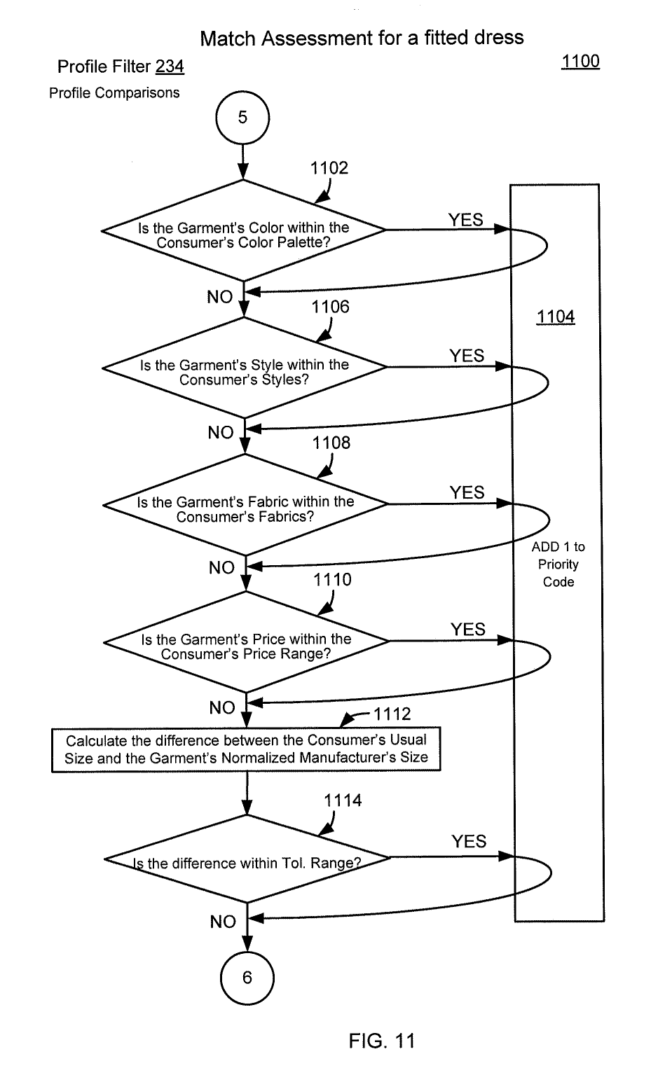

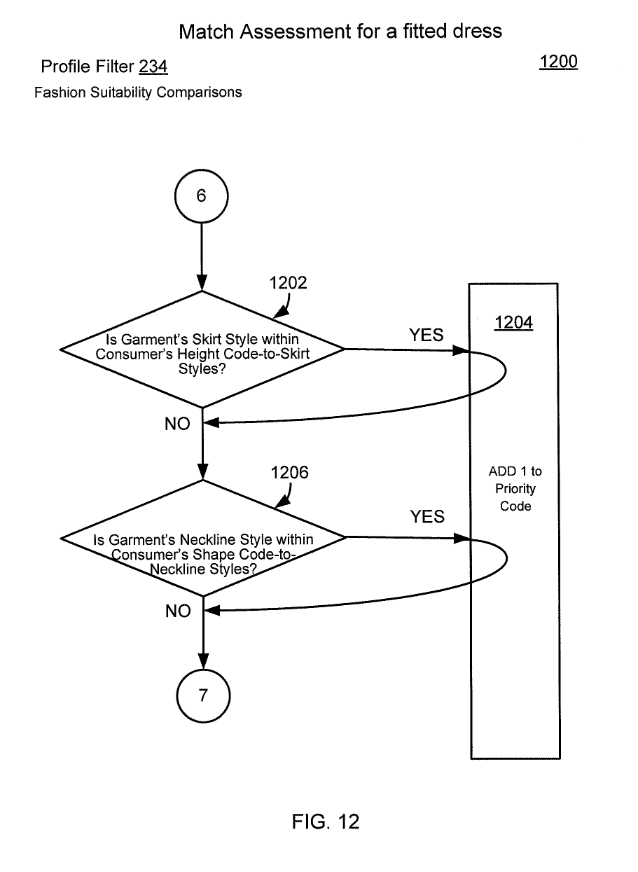

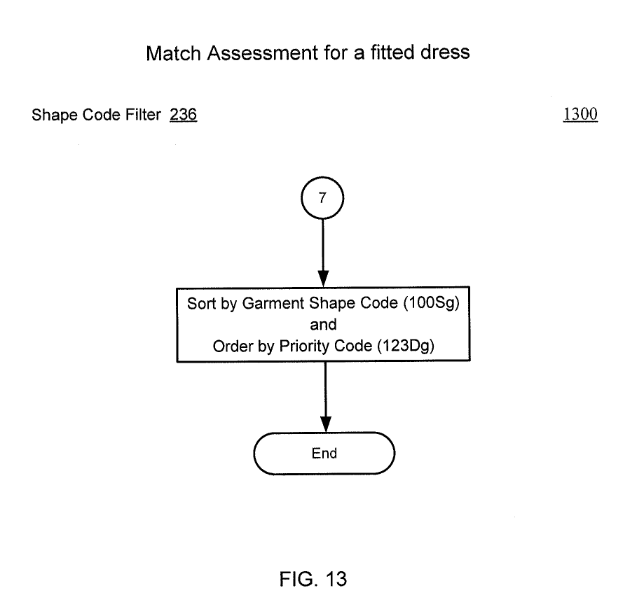

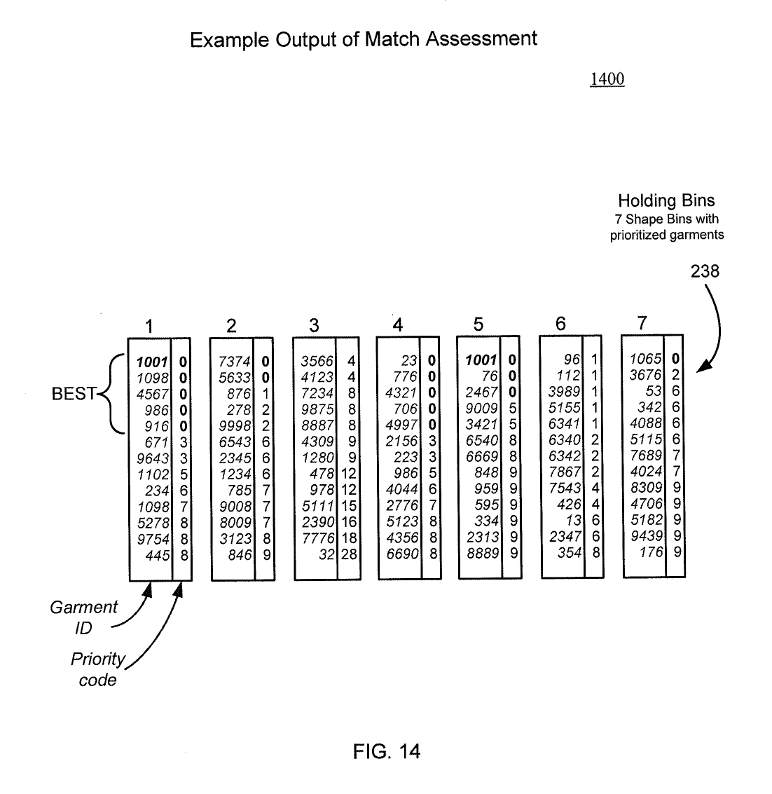

FIGS. 6-14 depict a match assessment process 230 and various elements thereof. The match assessment process treats both sewn clothing items and fashion accessories as garments. Thus it matches individual consumers with individual clothing items or individual accessories in the same manner and with equal efficacy. Further details of match assessment processes are taught in detail in Wannier I, II and/or III.

### Personalized Shopping Process

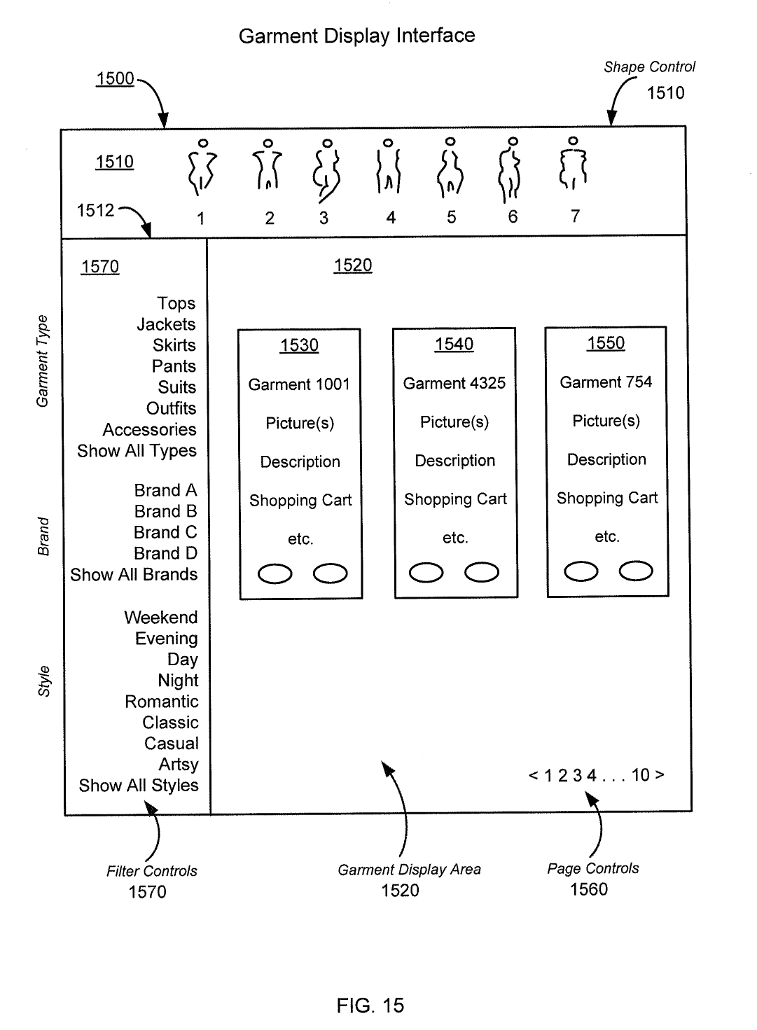

A personalized shopping process 240 presents a consumer with her personal online clothing store. In one embodiment, the consumer is presented with a personal store, which shows the customer garments, outfits and complementary accessories that match the customer's measurements, body shape, height code, personal preferences and fashion styling, that will fit her and flatter her as determined by the fashion suitability rules. In one embodiment, the results of a match assessment 230 of multiple garments and outfits may be displayed to the consumer using a graphical user interface (GUI) 1500 as depicted in FIG. 15. Further details of a personalized shopping process that might be used as the base for the present invention are taught in detail in Wannier I, II and/or III.

### Personal Mall

In addition to providing the consumer with a personalized store, elements of the systems described above can be expanded to cover a personal mall, wherein filtering is done as above, but over multiple online retail outlets. The particular retail outlets that are part of the system would depend on a number of criteria and the operator of the matching system might provide that access in exchange for commissions, as well as upselling, cross-marketing and providing other useful features for the consumer. An advantage to those retailers who join the personal mall and provide a virtual storefront is reduced return rates. With proper arrangement of the personal mall, each retail outlet can present its own brand and may be the shipper that ships the products directly to the consumer.

### Description of Embodiments

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

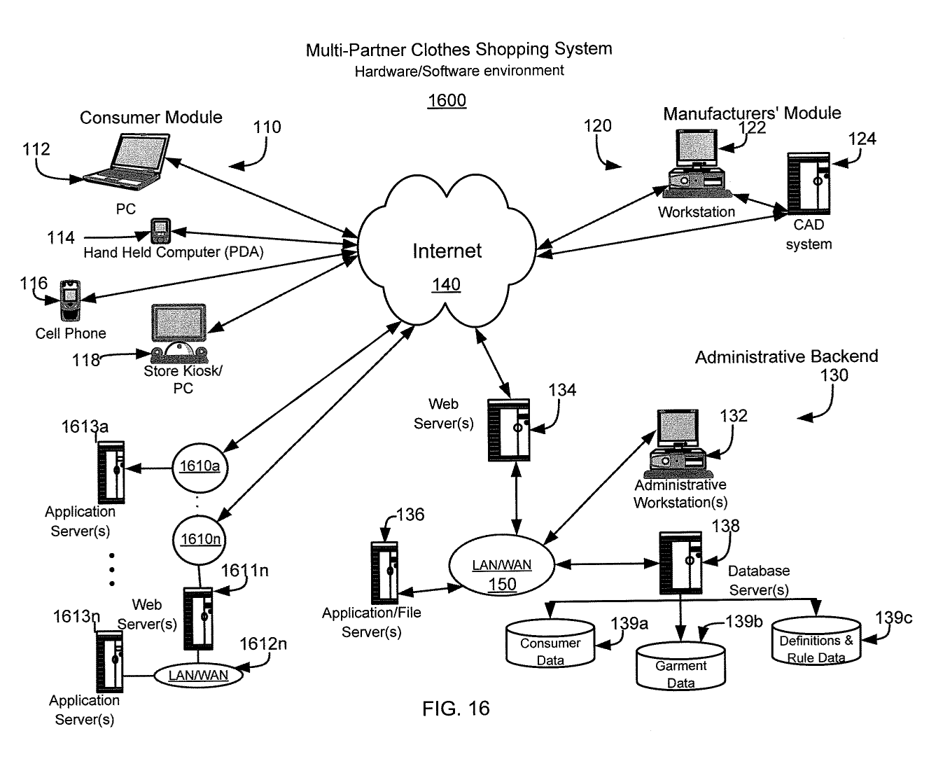

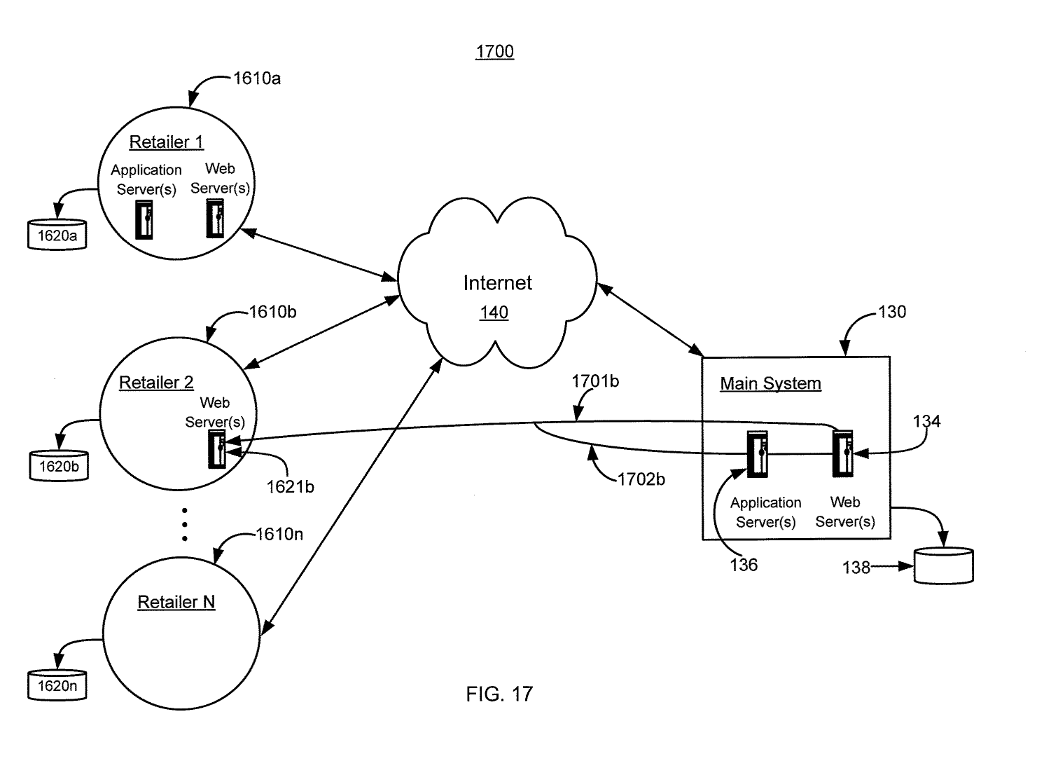

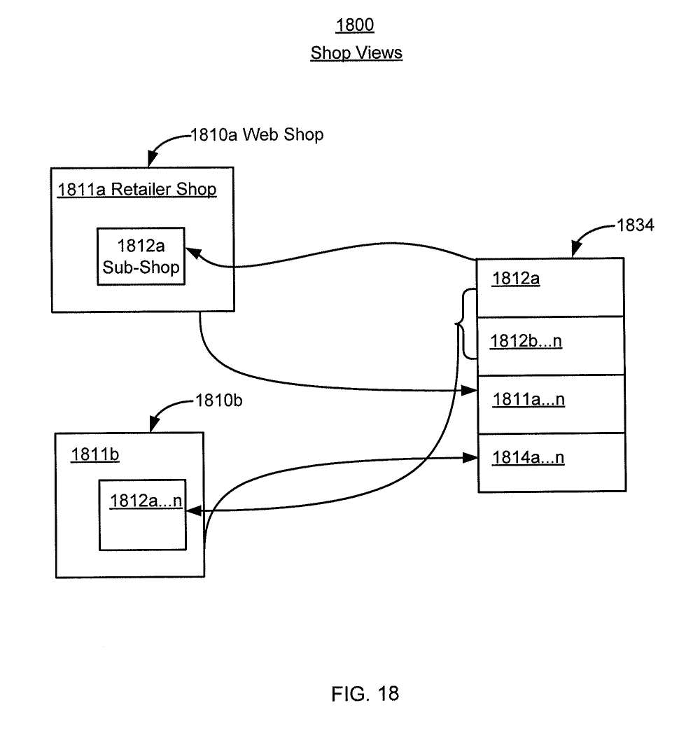

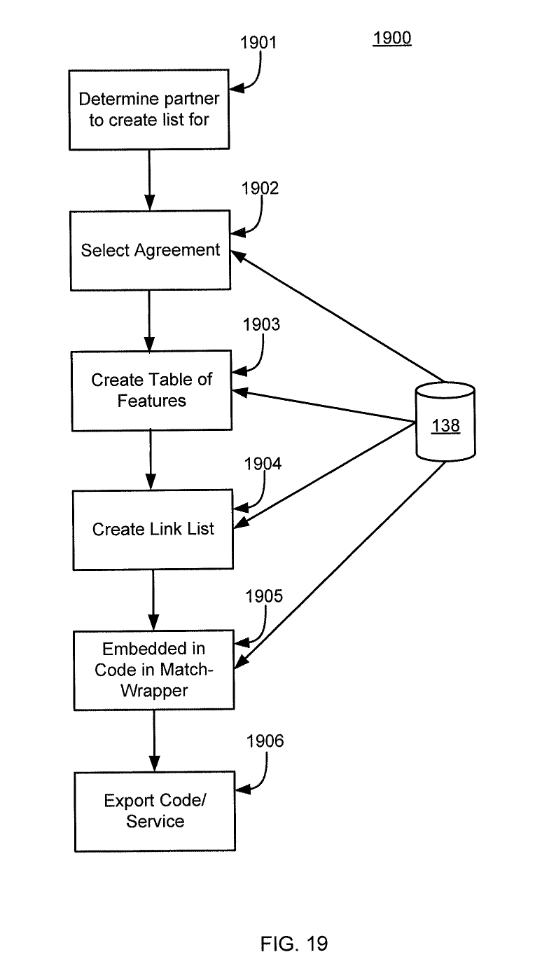

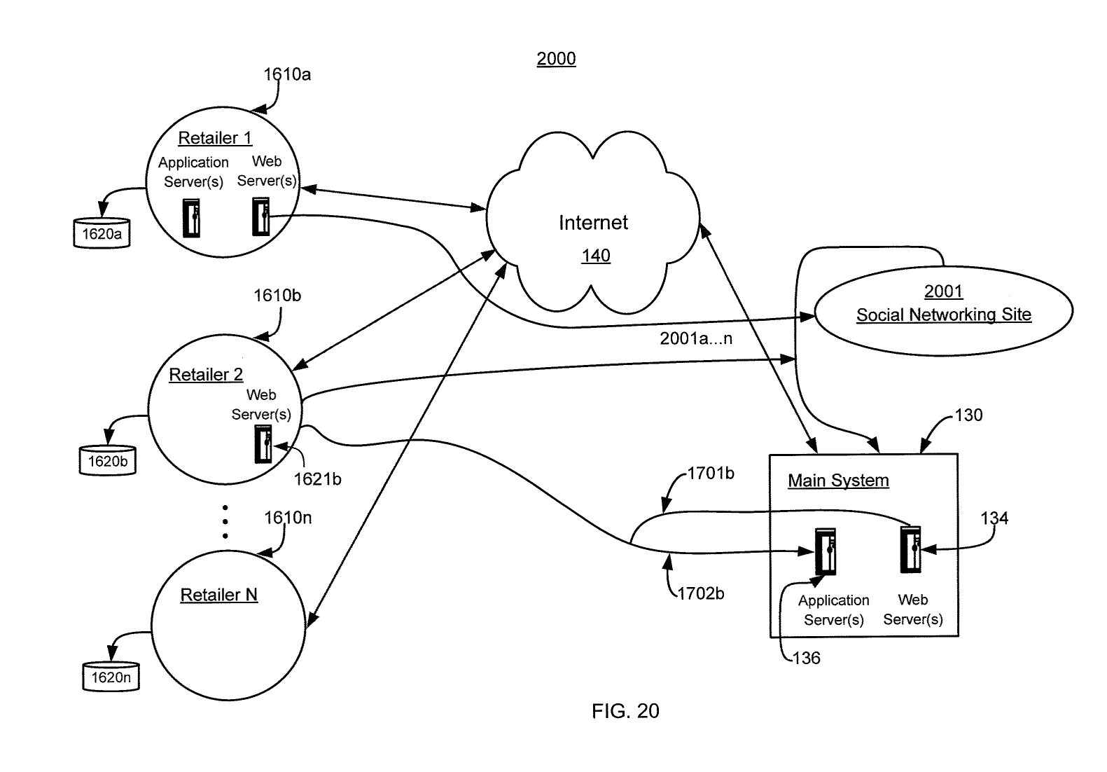

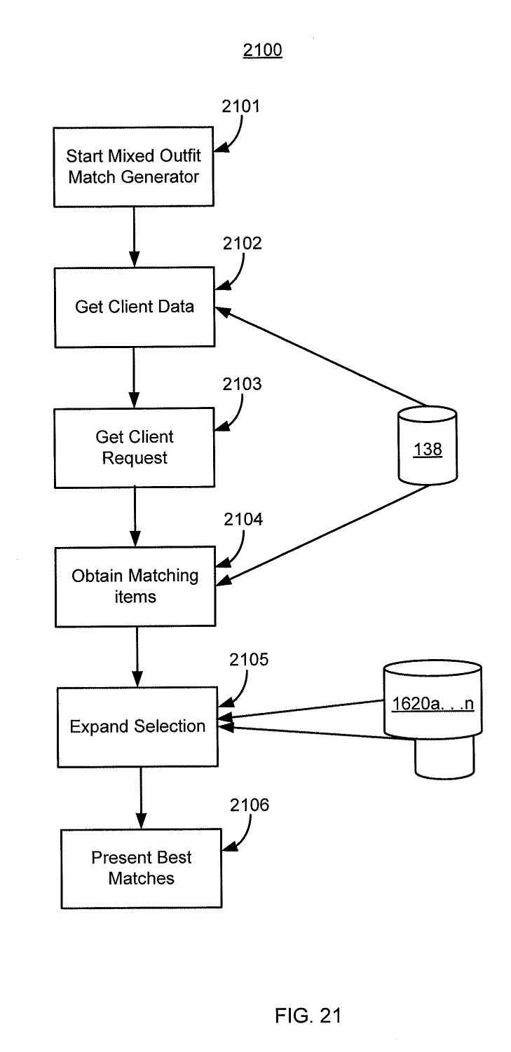

FIGS. 16-21 show an enhanced overview of a multi-partner clothes and accessories, shoes, purses, and all other products that include the notions of fashion and style, shopping system 1600. Further teachings along these lines are provided by Wannier III.

Using such a shopping system, several benefits are provided, such as a system and method for integrating embedded shops on multiple sites, linked to a virtual personal shopping channel where each person can instantly see within their personal shop the clothes and other fashion items that “match” a user's profile and fit and flatter within each node of the network. Those shops can be integrated with social networks and syndication of content for marketing products. The shopping system might generate product combinations from a plurality of inventories at a point of sale for a transaction and a system of soliciting interest in custom-made garments based on user indication, and in some cases including on-line closet representations of consumer-owned items.

The shopping system might allow for shopping of outfits or ensembles of items, allowing users to mix and match on any website or kiosk any part of such an outfit or ensemble, matching to other parts on other websites or items already owned by customer and/or known to the system.

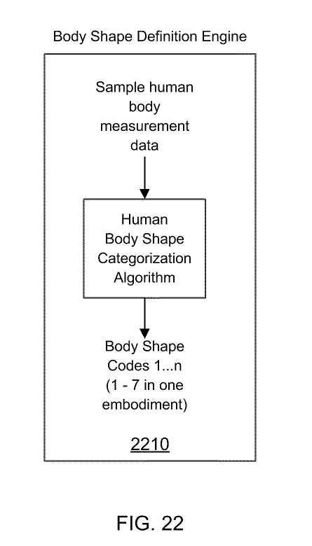

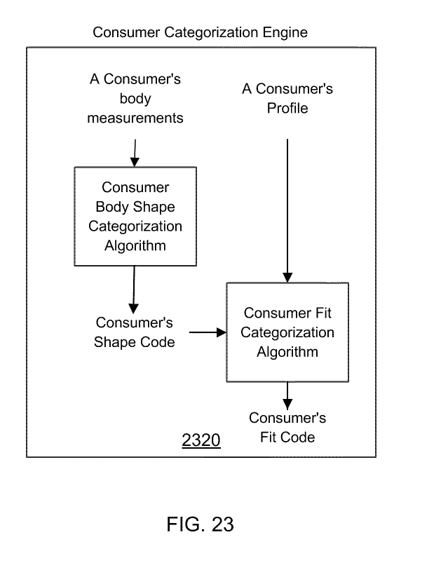

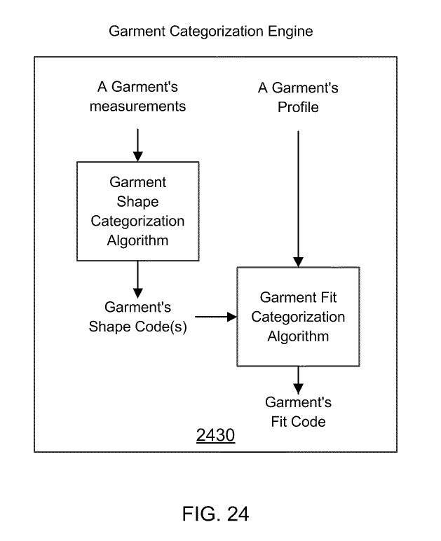

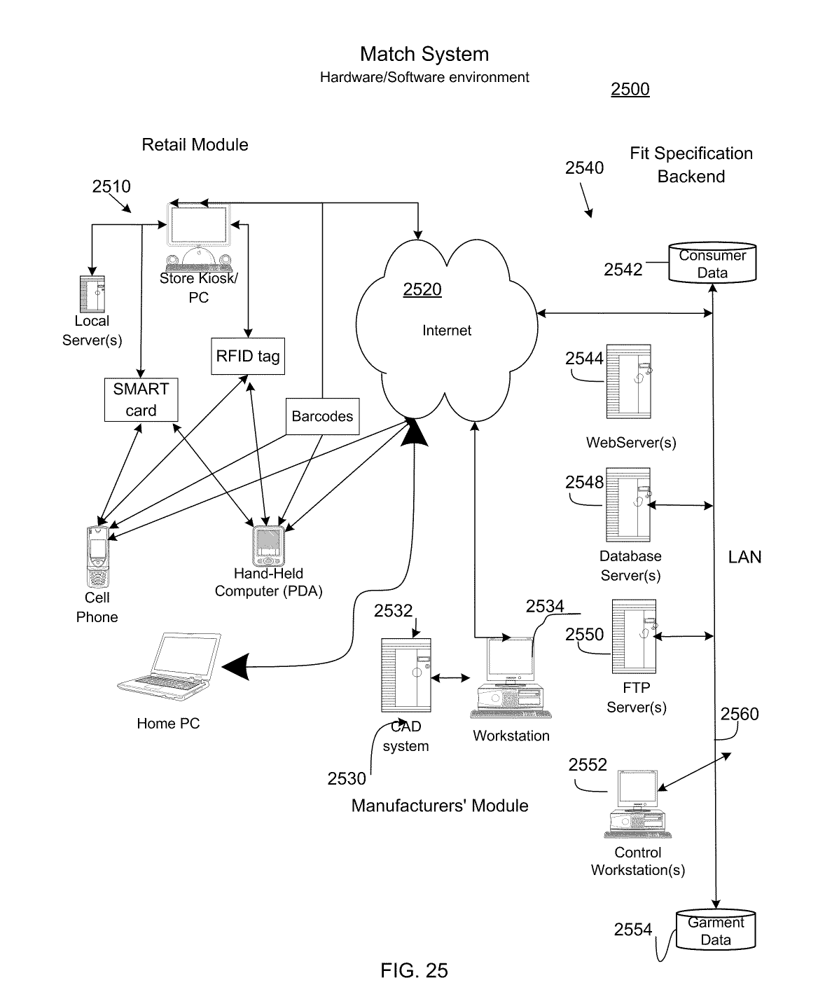

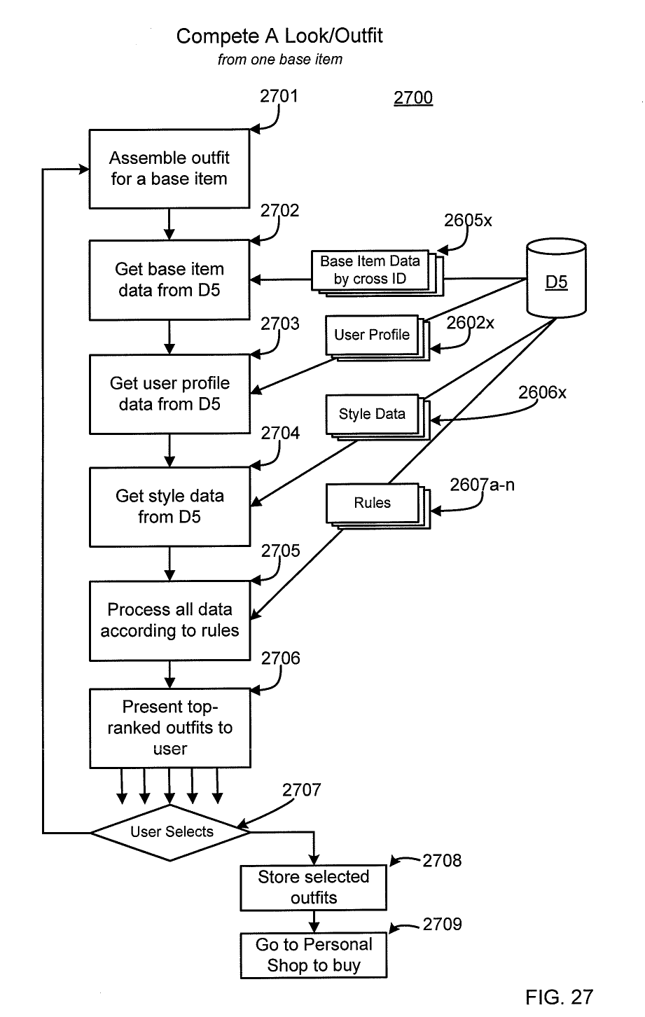

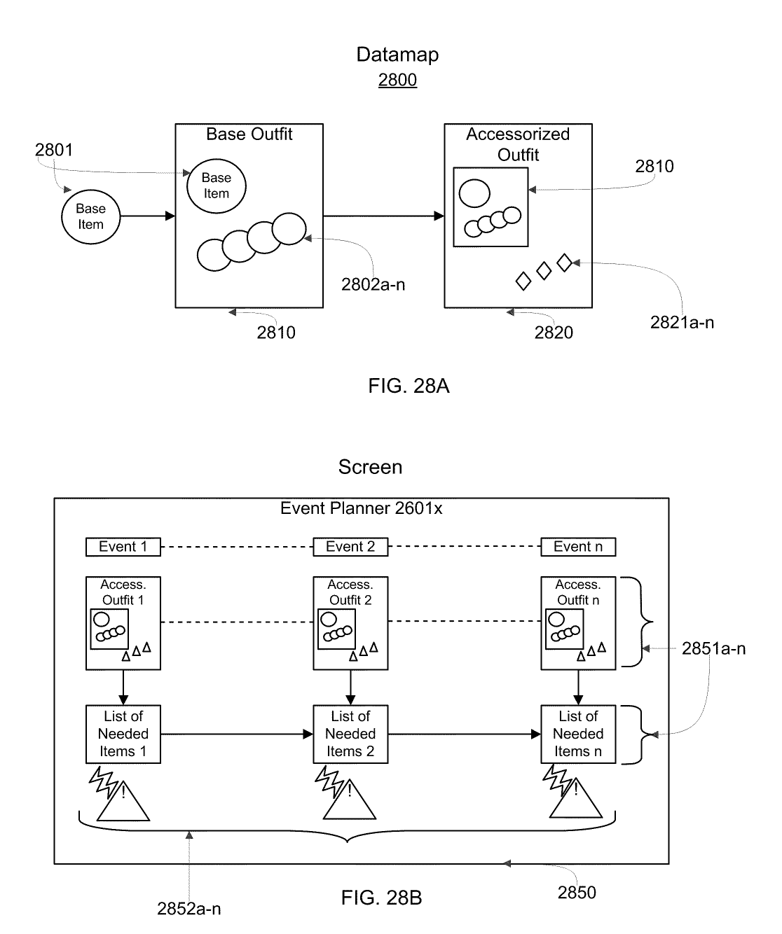

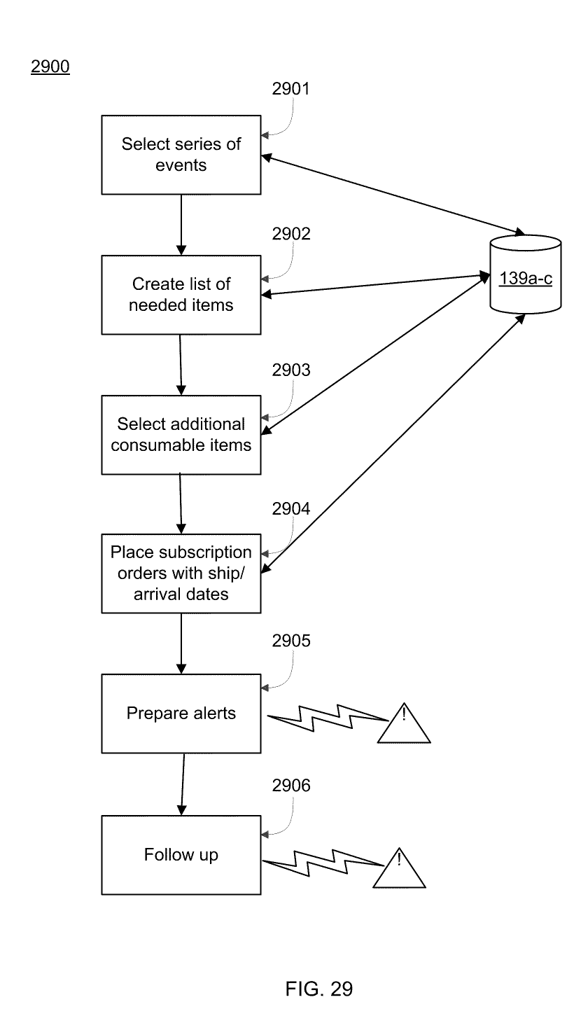

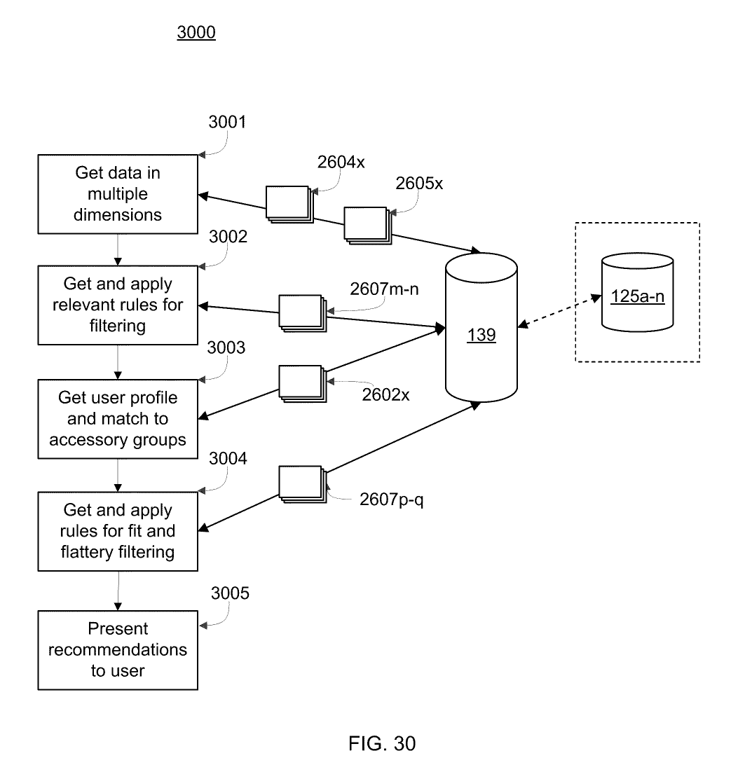

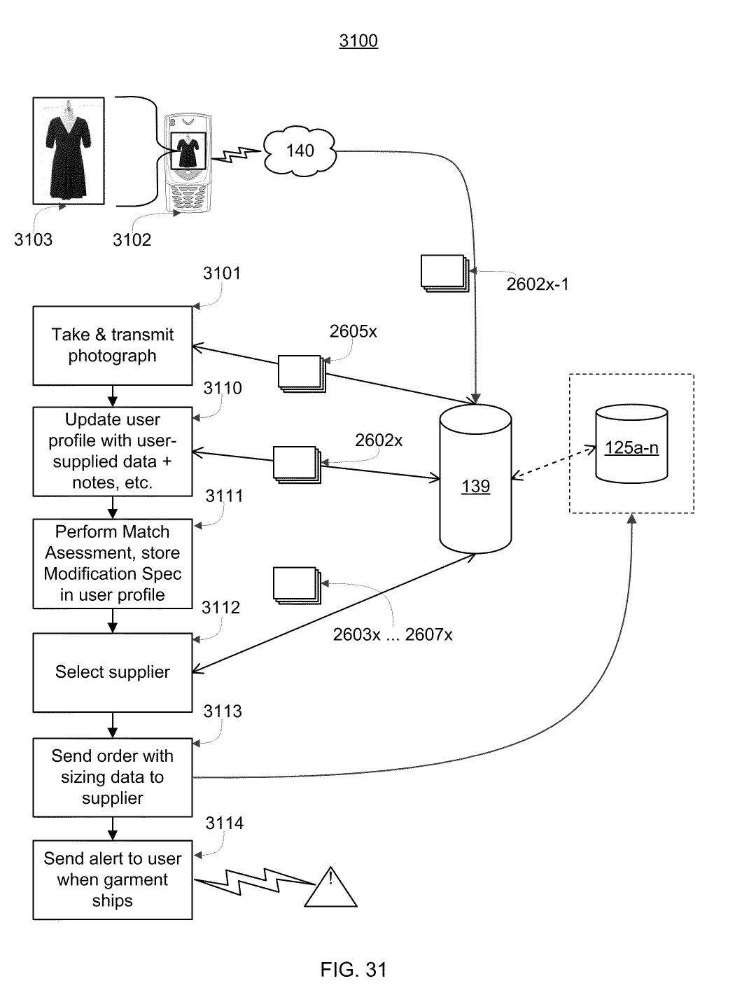

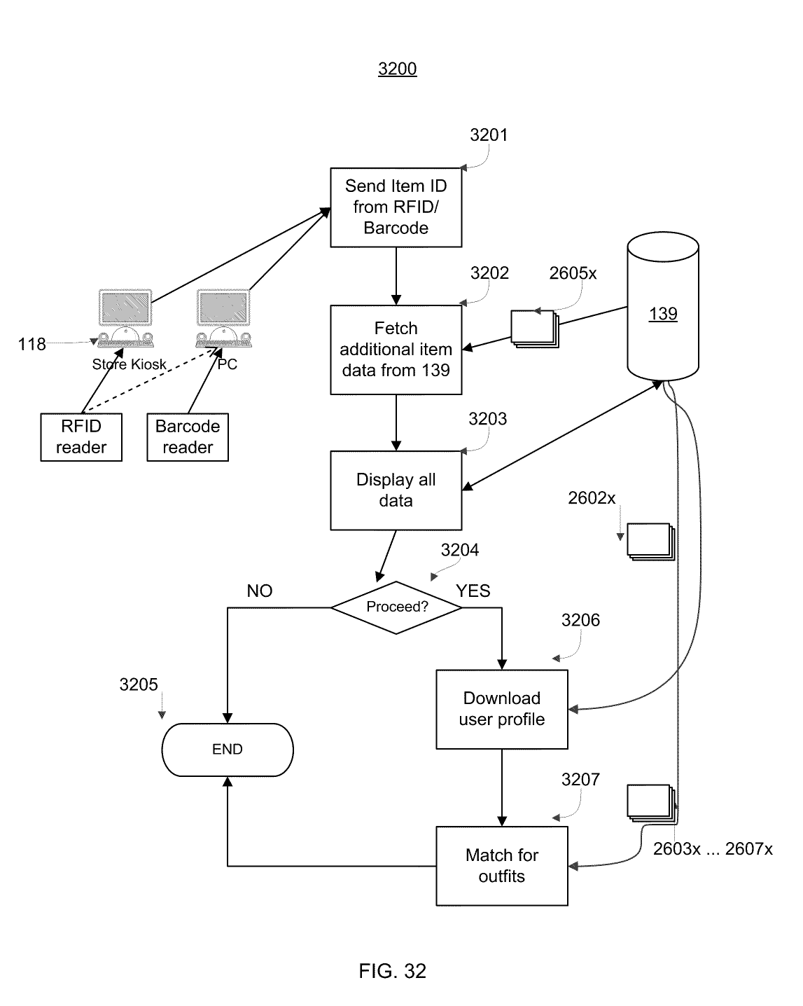

FIGS. 22-24 depict a categorization process 2205 that is described in greater detail in Wannier IV. Individual consumers can be categorized. FIGS. 25-32 shows a match system 2500 and processes used to enable a shopping process, each described in greater detail in Wannier IV.

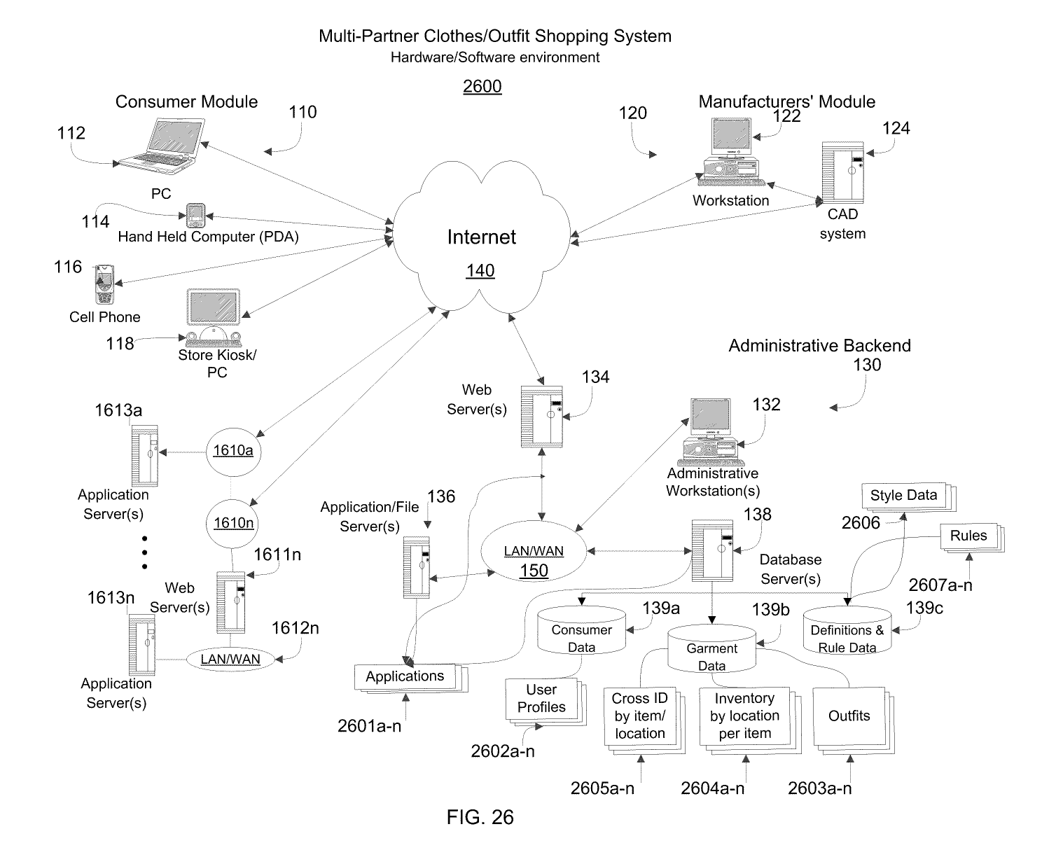

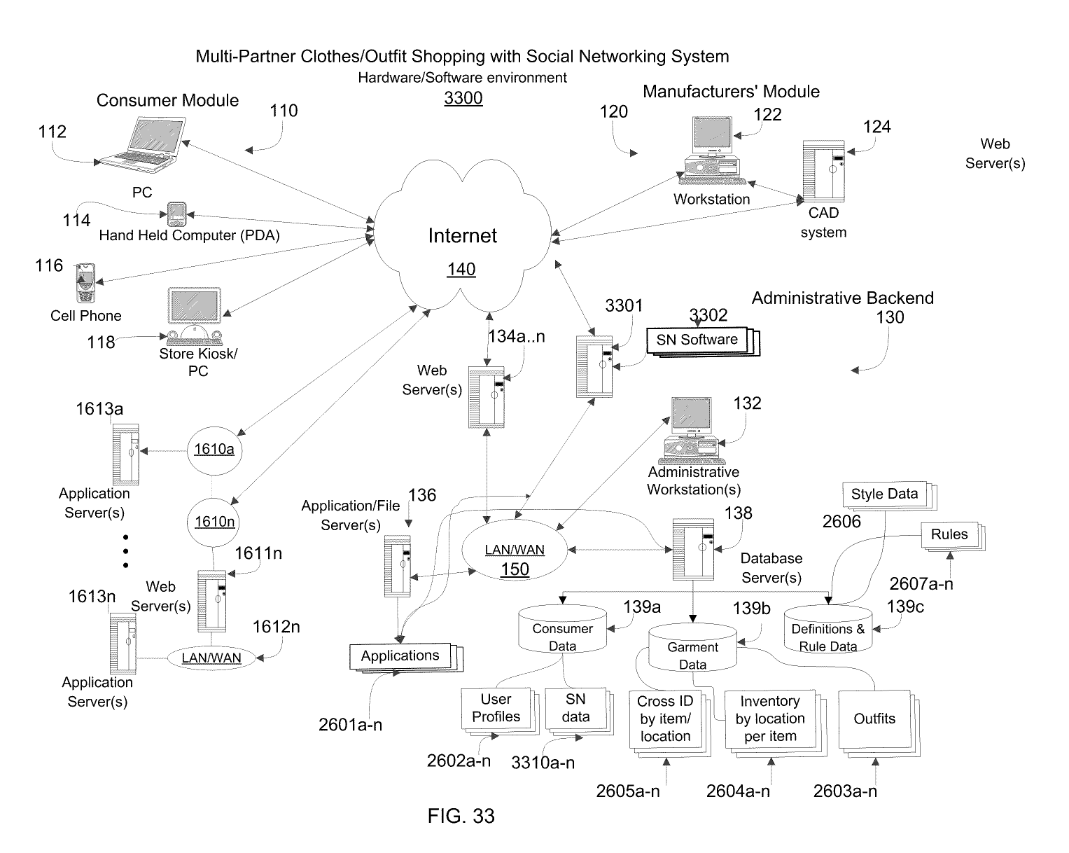

FIG. 33 shows an overview of an exemplary system 3300 according to one embodiment of the current invention. In addition to elements described in previous patents and co-pending applications referenced above with respect to FIG. 16 and FIG. 26, in particular user profiles 2602a-n, the system includes a social networking (SN) network server 3301 containing SN software 3302, which can be proprietary SN software (SNS) or a modified or adapted ready-made or third-party product. In some cases, the server with the SNS is connected as directly as possible to the Internet 140 (or another suitable network) as well as allowing SNS access to user data profiles 2602a-n and to other data. Data produced during sharing events can be exchanged with a number of applications 2601a-n running on one or more servers 134a-n.

In some instances, the SNS could also be co-located on one or more servers 134a-n. This approach allows items and events to be shared, as well as feedback given about shared information to be added, for example, to the user profile(s) 2602a-n or stored in a dedicated SNS store, such as dataset 3310a-n. In some cases, each partner site may have its own instances of SNS 3302 running locally in systems 1610a-n (not shown for purposes of clarity and simplicity), and these partner sites may even contain additional local data 1613a-n. Thus users 1610a-n can selectively share information with each other through SNS 3302, with the intent of improving the shopping experience via the ability to mutually share guidance, feedback or other advice.

The user may also include in his/her profile a list of what persons can contact or invite him/her, and the user may even have multiple profiles for shopping help depending on the occasion for which he/she is shopping. This information may also be stored in data sets 2602a-n, 3310a-n, or any other suitable available data store. Information can then be selectively shared via the software, which can then use or further share the information with others, for example to update shopping lists, wish lists, subscription lists, etc. Such lists are taught by related co-pending applications.

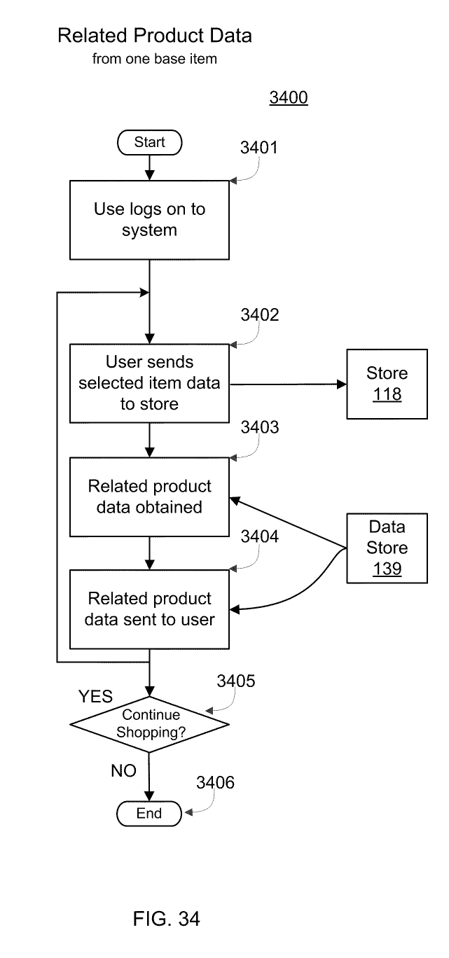

FIG. 34 shows an overview of an exemplary process 3400 according to the present invention for sending information to a user about other products that have been combined with a first product by other users. In step 3401, a user logs on to the system. In step 3402, the user sends information about a selected item to a store 118. In step 3403, the system obtains from data store 139 information about other users' use of the item, including lists of other products that other users have combined with the selected item or purchased with the item. In step 3404, the system sends information about other, related products to the user. In step 3405, the process branches. If the user wants to shop for more products (Yes), the process loops back to step 3402. If the user is finished shopping (No), the process ends at step 3406.

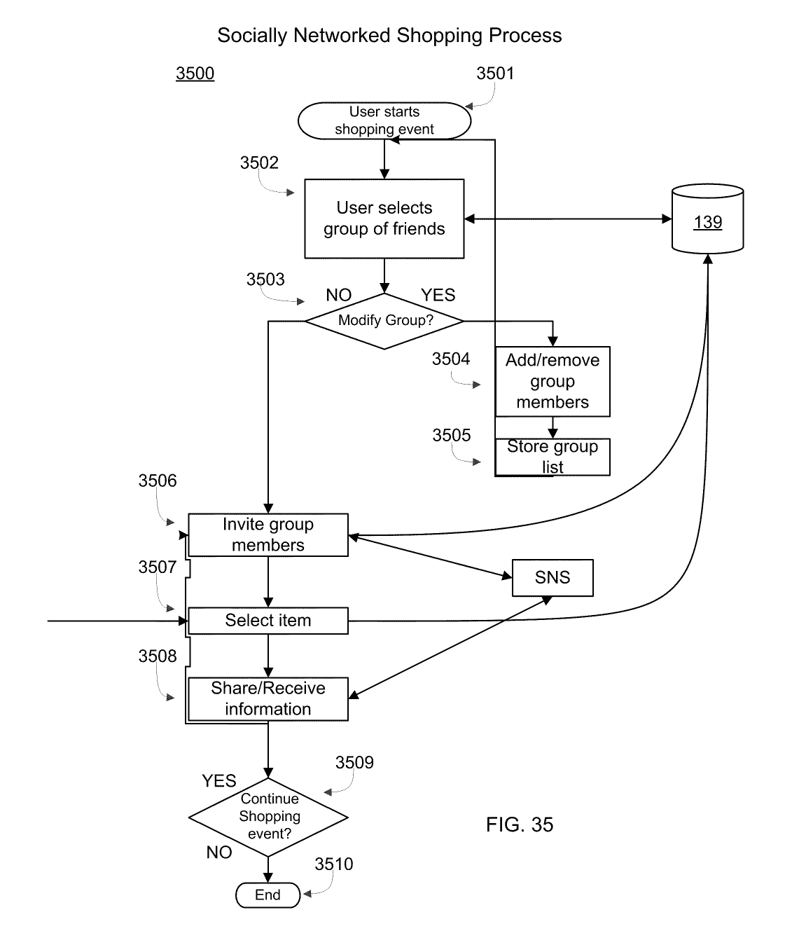

FIG. 35 shows an overview of an exemplary process 3500 according to the present invention for socially networked shopping. In step 3501, a user starts a shopping event. In step 3502, the user selects a group of friends with whom to shop, drawing data from the social network members listed in their user profile stored in data repository 139. After the group is selected, the system stores a record of the current list back into repository 139. In step 3503, the user may, if desired, elect to add or remove social network members to or from their profile data. If the user decides to thus modify their profile data group, in step 3504 the user adds or removes social network members, and in step 3505, the system stored the modified network list back into repository 139. The process then loops back to step 3502. If the user does not modify the social network members in their profile, the process moves to step 3506, where the user, through social networking server 3301 and application 3302 invites the selected members to participate in a shopping event. In step 3507, the user selects from data repository 139 an item to consider for purchase, and in step 3508 the user shares information about the item with other group members and receives feedback via the SNS. In step 3509 the user may finish shopping or continue the event. If the user continues the event, the process may loop back to step 3506, where the user may invite friends to participate, or back to step 3507, where the user selects an item with the current group of friends. If the user is through shopping, the process terminates at step 3510.

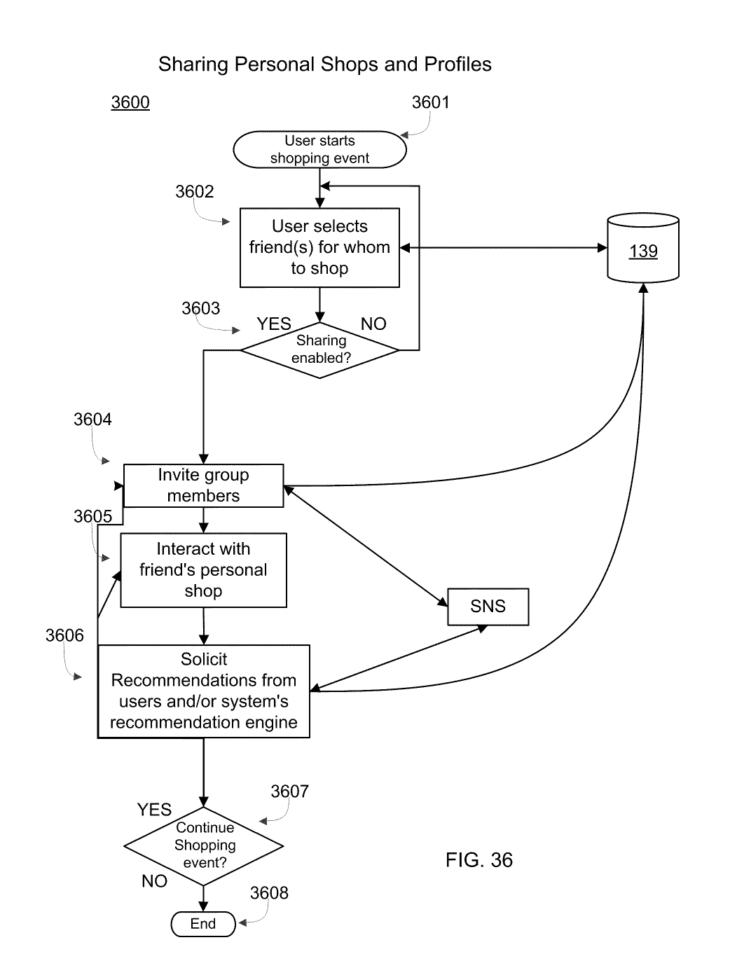

FIG. 36 shows an overview of an exemplary process 3600 according to the present invention for sharing personal shops and profiles. In step 3601, a user starts a shopping event. In step 3602 drawing data from the social network members listed in their user profile stored in data repository 139, the user selects a friend (or multiple friends) for whom she wants to shop. At step 3603 if the selected friend has enabled the sharing of her personal shop, the user is taken to the friend's personal shop and the shopping session commences. Following process 3500, at step 3604 the user may optionally invite other friends to join the shopping session. At step 3605 during the session the user is free to interact with her friend's personal shop to the extent the friend has enabled such interactions. Such interactions may include, but are not limited to, browsing the contents of the friend's personal shop, viewing the friend's wish list, perusing her personal profile and preferences, leaving comments and suggestions for the friend, assemble outfits, and ultimately selecting items to purchase for the friend. Using the access administration functions of social networking software 3302, the friend can control who has access to her personal shop, what areas are visible to what visitors, how much of her preferences and profile are visible, who many comment, suggest or buy, and the extent to which any visitor may interact with her personal shop. At step 3606 user may optionally solicit recommendations from other users for items to buy for the friend. The user may also solicit recommendations from the system for items to buy for the friend. Based on the friend's data profile, preferences, and purchase & click stream history 139a, the system uses well-know recommendation engine and collaborative filtering rules 139c to create a prioritized list of those items most likely to appeal to the friend and it presents that list to the user at step 3606. If the user continues the event, the process may loop back to step 3604, where the user may invite additional friends to participate, or back to step 3605, where the user continues interaction within the friend's personal shop. If the user is through shopping for the friend, the process terminates at step 3608.

Clearly, many variations can be made without departing from the spirit of the invention. For example, the system allows a multitiered social networking among users shopping at a common store, such as a website, allowing a selected group or subset to be brought along to an online shopping experience, and may in some cases hide the fact to others of who is doing what, to allow social secrets. Further, in some cases, the system may aid users wishing to find products that go well with each other, based on product combinations preferred by others, as released in their group, either by showing them the products or in some cases by allowing a user to contact certain strangers with similar needs for advice, thus allowing users to build new social groups. The system may also provide a feature to partners' websites allowing integration of the function from one website, such as a personal shop, to other websites or portions of websites of partners. Also, for example, the flowchart 3500 depicts a user selecting a group of people to shop with 3502, optionally editing the group 3503, inviting group members 3506, selecting an item for possible purchase and sharing it with the group 3508. In some cases, for further example, the order of this process may be different. For example, the user may already be shopping. She spots an item or items for which she'd like to get feedback from her friends, she invites them to join the shopping session already in progress. So in some cases, the process(es) may first start with other steps, for example with the user selecting one or more items to possibly purchase before selecting a group to share the shopping event. Also, examples of formats of information and or communications include but are not limited to shared or the techniques (VOIP, IM, HTML, online presence indication, etc.) Also, in step 3507, the user might select multiple items simultaneously for sharing

It should be clear that many modifications and variations of this embodiment may be made by one skilled in the art without departing from the spirit of the novel art of this disclosure. For example, in some cases customers may “shop together” in a “chat shop” approach, using means for online real time communication that are well know in current art, such as linking, for example, to Internet telephone and instant messaging systems, etc. Thus customers are shopping together while chatting, so each chatter can see the shop together with the others, and both synchronously and asynchronously add comments, etc. can buy a gift for the chattee's shop, etc. These modifications and variations do not depart from the broader spirit and scope of the invention, and the examples cited here are to be regarded in an illustrative rather than a restrictive sense.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. An online garment selection and acquisition system comprising at least a server computer system that receives requests from client computer systems and/or client devices and responds to those requests, wherein the server computer system is configured to be able to access a database system for reading data therefrom, online garment selection and acquisition system comprising:
a database system that includes a database server and a database for an inventory of garments, wherein the database includes a plurality of type parameters for garments in the inventory and at least at least one fit, shape, preference or style parameter;
program code for obtaining consumer data including one or more of consumer body shape, consumer proportion, consumer preferences;
program code for filtering the collection of garments according to one or more of consumer preference, consumer size, consumer measurements, consumer shape and parameters of the garments in the database to form a personalized selection of garments;
program code for tracking consumer interest in garments in the database of garments; program code for generating a presentation of at least one garment to allow for a consumer or consumer representative using the client computer systems and/or client devices to select and/or acquire the garment; and
program code for presenting a shared presentation to a client computer system and/or client device other than that of the consumer or consumer representative, thereby facilitating joint shopping.

2. The online garment selection and acquisition system of claim 1, wherein the program code for tracking consumer interest includes program code to record page requests from client computers and/or devices.

3. The online garment selection and acquisition system of claim 2, wherein the recorded page requests include clickstream records and viewing times for a plurality of pages.

4. The online garment selection and acquisition system of claim 1, wherein the program code for tracking consumer interest includes program code to accept consumer inputs as to wish list items.

5. The online garment selection and acquisition system of claim 1, further comprising program code to store comments in consumer records for a first user where the comments originate from a second user and relate to a garment or other item for which the system has determined an interest on the part of the first user.

6. The online garment selection and acquisition system of claim 1, wherein the database of garments comprises clothing, shoes, accessories and/or other fashion items that can be grouped into outfits.

7. The online garment selection and acquisition system of claim 1, wherein the client computer systems comprise one or more of in-store kiosks, home computers, general purpose computers, handheld devices, laptop computers, cellular telephones, PDAs, and/or netbook computers.

8. The online garment selection and acquisition system of claim 1, wherein the program code for filtering is program code for filtering based on calculations that estimate a degree to which a garment or accessory might fit or flatter the consumer, given the characterization of the garment or accessory and given the consumer body shape, measurements and/or fit preferences.

9. The online garment selection and acquisition system of claim 1, further comprising a display device as part of the client computer systems, wherein the display device is configured to display the generated presentation and the client system is configured to accept navigation commands from the consumer or consumer representative and to accept input commands from the consumer or consumer representative that signal selection requests.

10. The online garment selection and acquisition system of claim 1, further comprising program code to match a plurality of garments into an outfit and store comments in consumer records for a first user where the comments originate from a second user and relate to an outfit for which the system has determined an interest on the part of the first user.

11. The online garment selection and acquisition system of claim 1, further comprising:
program code to store comments in consumer records for a first user where the comments originate from a second user and relate to a garment or other item for which the system has determined an interest on the part of the first user;
program code to control access to information about the first user by access of one or more second user; and
program code to control which second users can provide comments on which garments or other items.

12. An online garment selection and acquisition system comprising at least a server computer system that receives requests from client computer systems and/or client devices and responds to those requests, wherein the server computer system is configured to be able to access a database system for reading data therefrom, online garment selection and acquisition system comprising:
a database system that includes a database server and a database for an inventory of garments, wherein the database includes a plurality of type parameters for garments in the inventory and at least at least one fit, shape, preference or style parameter;
program code for obtaining consumer data including one or more of consumer body shape, consumer proportion, consumer preferences;
program code for tracking consumer interest in garments in the database of garments;
program code for generating a presentation of at least one garment to allow for a consumer or consumer representative using the client computer systems and/or client devices to select and/or acquire the garment;
program code for presenting a shared presentation to a client computer system and/or client device other than that of the consumer or consumer representative;
program code for tracking consumer interest includes program code to record page requests from client computers and/or devices;
program code for tracking consumer interest includes program code to accept consumer inputs as to wish list items;
program code to store comments in consumer records for a first user where the comments originate from a second user and relate to a garment or other item for which the system has determined an interest on the part of the first user.
